(19) United States
(12) Patent Application Publication
(10) Pub. No.: US 2026/0332456 A1
(43) Pub. Date: Oct. 22, 2026

(54) INFORMATION TRANSMISSION METHOD AND APPARATUS

(71) Applicant: HUAWEI TECHNOLOGIES CO., LTD., Shenzhen (CN)

(72) Inventors: Jian Wang, Hangzhou (CN); Gongzheng Zhang, Hangzhou (CN); Rong Li, Boulogne Billancourt (FR)

(73) Assignee: HUAWEI TECHNOLOGIES CO., LTD., Shenzhen (CN)

(21) Appl. No.: 19/457,574

(22) Filed: Jan. 23, 2026

Related U.S. Application Data
(63) Continuation of application No. PCT/CN2023/113402, filed on Aug. 16, 2023.

(51) Int. Cl. H04L 25/02; G06N 3/0455; H04B 7/06

(52) U.S. Cl. CPC H04L 25/0248; G06N 3/0455; H04B 7/0626

(57) ABSTRACT

Embodiments of this application provide an information transmission method and an apparatus. The method includes: A first device determines a first encoder and a first decoder. The first device performs channel estimation based on a second reference signal from a second device to determine second CSI, compresses the second CSI by using the first encoder to obtain first channel feature information, and sends the first channel feature information to the second device. The second device performs channel estimation based on a first reference signal from the first device, to determine first CSI, and the second device determines the first encoder or the first decoder based on the first CSI and the first channel feature information. A channel corresponding to the first reference signal and a channel corresponding to the second reference signal are reciprocal. The method can reduce communication overheads.

### CROSS-REFERENCE TO RELATED APPLICATIONS

This application is a continuation of International Application No. PCT/CN2023/113402, filed on Aug. 16, 2023, the disclosure of which is hereby incorporated by reference in its entirety.

### TECHNICAL FIELD

This application relates to the field of communication technologies, and in particular, to an information transmission method and an apparatus.

### BACKGROUND

In a wireless communication system, a multiple-input multiple-output (MIMO) technology may be used to increase a system capacity. In such a scenario, a network device may precode a to-be-sent signal before sending the signal to a terminal device. This helps suppress interference caused by using a plurality of antennas in the MIMO technology. Specifically, the network device may send a downlink reference signal (RS) to the terminal device, and the terminal device may perform channel estimation based on the downlink reference signal, and feed back obtained channel state information (CSI) to the network device. Then, the network device may precode the to-be-sent signal based on the CSI fed back by the terminal device.

In a manner, CSI feedback may be implemented between the network device and the terminal device based on an autoencoder. The autoencoder includes an encoder and a decoder. The encoder is deployed on the terminal device, and the decoder is deployed on the network device. In this way, the terminal device may compress the CSI by using the encoder, and then send channel feature information obtained through compression to the network device. The network device may decompress the received channel feature information by using the decoder, to obtain the CSI.

A technical problem that needs to be resolved is how to reduce communication overheads in a process in which the encoder and the decoder are separately deployed on the network device and the terminal device.

### SUMMARY

Embodiments of this application provide an information transmission method and an apparatus, to reduce communication overheads.

According to a first aspect, this application provides an information transmission method. The method may be applied to a second device, may be applied to a chip in the second device, or may be applied to a logical module or software that can implement all or some functions of the second device. The following uses the second device as an example for description. The method includes: The second device performs channel estimation based on a first reference signal from a first device, to determine first CSI; the second device sends a second reference signal to the first device, where the second reference signal is used by the first device to perform channel estimation to determine second CSI; the second device receives first channel feature information from the first device, where the first channel feature information is obtained by compressing, by the first device, the second CSI by using a first encoder; and the second device determines the first encoder or a first decoder based on the first CSI and the first channel feature information. A channel corresponding to the first reference signal and a channel corresponding to the second reference signal are reciprocal.

The first encoder and the first decoder belong to a same autoencoder, and the first encoder and the first decoder adapt to each other. Because the channel corresponding to the first reference signal and the channel corresponding to the second reference signal are reciprocal, a channel feature corresponding to the first reference signal is basically the same as a channel feature corresponding to the second reference channel, and the first CSI determined by performing, by the second device, channel estimation based on the first reference signal is basically the same as the second CSI determined by performing, by the first device, channel estimation based on the second reference signal. In this case, channel feature information obtained by compressing the first CSI by the second device by using the first encoder is basically the same as the first channel feature information obtained by compressing the second CSI by the first device by using the first encoder. Therefore, the second device may determine the first encoder based on the first CSI and the first channel feature information. In addition, because the first CSI determined by performing channel estimation by the second device based on the first reference signal is basically the same as the second CSI determined by performing channel estimation by the first device based on the second reference signal, CSI obtained by decompressing the first channel feature information by the second device by using the first decoder is basically the same as the first CSI. Therefore, the second device may determine the first decoder based on the first channel feature information and the first CSI.

It can be learned that, in the information transmission method, reciprocity between the channel corresponding to the first reference signal and the channel corresponding to the second reference signal is used, so that the second device determines the first encoder that adapts to the first decoder in the first device, or the second device determines the first decoder that adapts to the first encoder in the first device. In the information transmission method, the first device does not need to send the second CSI to the second device, so that communication overheads can be reduced. In addition, in the information transmission method, the first device does not need to directly send, to the second device, a model parameter of an encoder obtained through joint training or a model parameter of a decoder obtained through joint training, to ensure that the encoder or the decoder in the first device is private. This helps improve privacy security of the encoder or the decoder in the first device when the first device and the second device are from different vendors.

In an embodiment, that the second device performs channel estimation based on the first reference signal from the first device, to determine the first CSI includes: The second device performs channel estimation based on the first reference signal, to obtain first channel estimation information, where the first CSI is the first channel estimation information; or the first CSI is an eigenvalue or an eigenvector of a channel matrix corresponding to the first channel estimation information.

In an embodiment, that the second device performs channel estimation based on the first reference signal from the first device, to determine the first CSI includes: The second device performs channel estimation based on the first reference signal, to obtain first channel estimation information; and the second device performs eigen-decomposition, for example, singular value decomposition (SVD), on the first channel estimation information, to obtain the first CSI.

In an embodiment, that the second CSI is determined by performing, by the first device, channel estimation based on the second reference signal includes: Second channel estimation information is obtained by performing, by the first device, channel estimation based on the second reference signal; and the second CSI is the second channel estimation information; or the second CSI is an eigenvalue or an eigenvector of a channel matrix corresponding to the second channel estimation information.

In an embodiment, that the second device performs channel estimation based on the first reference signal from the first device, to determine the first CSI includes: The second device performs channel estimation based on the first reference signal, to obtain first channel estimation information; and the second device transforms the first channel estimation information by using a channel transformation machine learning model, to obtain third channel estimation information, where the first CSI is the third channel estimation information; or the first CSI is an eigenvalue or an eigenvector of a channel matrix corresponding to the third channel estimation information.

In an embodiment, that the second device performs channel estimation based on the first reference signal from the first device, to determine the first CSI includes: The second device performs channel estimation based on the first reference signal, to obtain first channel estimation information; the second device transforms the first channel estimation information by using a channel transformation machine learning model, to obtain third channel estimation information; and the second device performs eigen-decomposition, for example, SVD, on the third channel estimation information, to obtain the first CSI.

In an embodiment, that the second device performs channel estimation based on the first reference signal from the first device, to determine the first CSI includes: The second device performs channel estimation based on the first reference signal, to obtain first channel estimation information; and the second device transforms, by using a channel transformation machine learning model, an eigenvalue or an eigenvector of a channel matrix corresponding to the first channel estimation information, to obtain the first CSI.

In an embodiment, that the second device performs channel estimation based on the first reference signal from the first device, to determine the first CSI includes: The second device performs channel estimation based on the first reference signal, to obtain first channel estimation information; the second device performs eigen-decomposition, for example, SVD, on the first channel estimation information, to obtain an eigenvalue or an eigenvector of a channel matrix corresponding to the first channel estimation information; and the second device transforms, by using a channel transformation machine learning model, an eigenvalue or an eigenvector of a channel matrix corresponding to the first channel estimation information, to obtain the first CSI.

The channel transformation machine learning model is related to channel data distribution. In an implementation, the second device transforms the first channel estimation information by using the channel transformation machine learning model. In an alternative implementation, the second device transforms, by using the channel transformation machine learning model, the eigenvalue or the eigenvector of the channel matrix corresponding to the first channel estimation information. In this way, when channel data distribution in an actual deployment scenario of the first encoder and the first decoder is different from channel data distribution corresponding to the first reference signal and the second reference signal, the first CSI can represent a channel feature in the actual deployment scenario. This helps alleviate, in the actual deployment scenario, performance deterioration of the first encoder or the first decoder that is determined by the second device based on the first CSI, that is, reduce, in the actual deployment scenario, a deviation between channel state information recovered by the first decoder and actual channel state information input into the first encoder, to help improve communication quality.

In an embodiment, that the second CSI is determined by performing, by the first device, channel estimation based on the second reference signal includes: Second channel estimation information is obtained by performing, by the first device, channel estimation based on the second reference signal; fourth channel estimation information is obtained by transforming, by the first device, the second channel estimation information by using a channel transformation machine learning model; and the second CSI is the fourth channel estimation information; or the second CSI is an eigenvalue or an eigenvector of a channel matrix corresponding to the fourth channel estimation information.

In an embodiment, that the second CSI is determined by performing, by the first device, channel estimation based on the second reference signal includes: Second channel estimation information is obtained by performing, by the first device, channel estimation based on the second reference signal; and the second CSI is obtained by transforming, by using a channel transformation machine learning model, an eigenvalue or an eigenvector of a channel matrix corresponding to the second channel estimation information.

The channel transformation machine learning model is related to channel data distribution. In an implementation, the fourth channel estimation information is obtained by transforming, by the first device, the second channel estimation information by using the channel transformation machine learning model. In an alternative implementation, the second CSI is obtained by transforming, by using the channel transformation machine learning model, the eigenvalue or the eigenvector of the channel matrix corresponding to the second channel estimation information. In this way, when channel data distribution in an actual deployment scenario of the first encoder and the first decoder is different from channel data distribution corresponding to the first reference signal and the second reference signal, the second CSI can represent a channel feature in the actual deployment scenario. This helps alleviate, in the actual deployment scenario, performance deterioration of the first encoder or the first decoder that is determined by the second device based on the first channel feature information, that is, reduce, in the actual deployment scenario, a deviation between channel state information recovered by the first decoder and actual channel state information input into the first encoder, to help improve communication quality.

In an embodiment, after the second device determines the first encoder based on the first CSI and the first channel feature information, the method further includes: The second device transforms the first encoder by using a parameter sharing machine learning model, to obtain a second encoder.

In an embodiment, after the second device determines the first decoder based on the first CSI and the first channel feature information, the method further includes: The second device transforms the first decoder by using a parameter sharing machine learning model, to obtain a second decoder.

The parameter sharing machine learning model is related to a communication system parameter configuration. The communication system parameter configuration may include one or more of the following: a quantity of antenna units, a quantity of antenna ports, a quantity of spatial streams, and the like. The first encoder and the first decoder are transformed by using the parameter sharing machine learning model, so that when a communication system parameter configuration in an actual deployment scenario of the first encoder and the first decoder is different from a communication system parameter configuration in a scenario in which the second device determines the first encoder, the second encoder and the second decoder that are obtained through transformation is applicable to the actual deployment scenario, to improve communication quality.

In an embodiment, the first reference signal is a downlink reference signal, and the second reference signal is an uplink reference signal; the second device is a terminal device or a chip in the terminal device, and the first device is a network device or a chip in the network device; and the second device determines the first encoder based on the first CSI and the first channel feature information.

In an embodiment, the method further includes: The second device receives one or more of the following from the first device: first information, second information, and third information, where the first information indicates a time-frequency resource position of the first reference signal; the second information indicates a time-frequency resource position of the second reference signal; and the third information indicates a time-frequency resource position of the first channel feature information.

In an embodiment, the first reference signal is an uplink reference signal, and the second reference signal is a downlink reference signal; the second device is a network device or a chip in the network device, and the first device is a terminal device or a chip in the terminal device; and the second device determines the first decoder based on the first CSI and the first channel feature information.

In an embodiment, the method further includes: The second device sends one or more of the following to the first device: first information, second information, and third information, where the first information indicates a time-frequency resource position of the first reference signal; the second information indicates a time-frequency resource position of the second reference signal; and the third information indicates a time-frequency resource position of the first channel feature information.

According to a second aspect, this application provides an information transmission method. The method may be applied to a first device, may be applied to a chip in the first device, or may be applied to a logical module or software that can implement all or some functions of the first device. The following uses the first device as an example for description. The method includes: The first device determines a first encoder and a first decoder; the first device sends a first reference signal to a second device, where the first reference signal is used by the second device to perform channel estimation to determine first CSI; the first device performs channel estimation based on a second reference signal from the second device, to determine second CSI; the first device compresses the second CSI by using the first encoder, to obtain first channel feature information; and the first device sends the first channel feature information to the second device. The first CSI and the first channel feature information are used by the second device to determine the first encoder or the first decoder, and a channel corresponding to the first reference signal and a channel corresponding to the second reference signal are reciprocal.

The first encoder and the first decoder belong to a same autoencoder, and the first encoder and the first decoder adapt to each other. Because the channel corresponding to the first reference signal and the channel corresponding to the second reference signal are reciprocal, a channel feature corresponding to the first reference signal is basically the same as a channel feature corresponding to the second reference channel, and the second CSI determined by performing, by the first device, channel estimation based on the second reference signal is basically the same as the first CSI determined by performing, by the second device, channel estimation based on the first reference signal. In this case, the first channel feature information obtained by compressing, by the first device, the second CSI by using the first encoder is basically the same as channel feature information obtained by compressing, by the second device, the first CSI by using the first encoder. Therefore, in this method, the second device may determine the first encoder based on the first CSI and the first channel feature information. In addition, because the second CSI determined by performing, by the first device, channel estimation based on the second reference signal is basically the same as the first CSI determined by performing, by the second device, channel estimation based on the first reference signal, CSI obtained by decompressing, by the second device, the first channel feature information by using the first decoder is basically the same as the first CSI. Therefore, in this method, the second device may determine the first decoder based on the first channel feature information and the first CSI.

It can be learned that, in the information transmission method, reciprocity between the channel corresponding to the first reference signal and the channel corresponding to the second reference signal is used, so that the second device determines the first encoder that adapts to the first decoder in the first device, or the second device determines the first decoder that adapts to the first encoder in the first device. In the information transmission method, the first device does not need to send the second CSI to the second device, so that communication overheads can be reduced. In addition, in the information transmission method, the first device does not need to directly send, to the second device, a model parameter of an encoder obtained through joint training or a model parameter of a decoder obtained through joint training, to ensure that the encoder or the decoder in the first device is private. This helps improve privacy security of the encoder or the decoder in the first device when the first device and the second device are from different vendors.

In an embodiment, that the first device performs channel estimation based on the second reference signal from the second device, to determine the second CSI includes: The first device performs channel estimation based on the second reference signal, to obtain second channel estimation information; and the second CSI is the second channel estimation information; or the second CSI is an eigenvalue or an eigenvector of a channel matrix corresponding to the second channel estimation information.

In an embodiment, that the first device performs channel estimation based on the second reference signal from the second device, to determine the second CSI includes: The first device performs channel estimation based on the second reference signal, to obtain second channel estimation information; and the first device performs eigen-decomposition, for example, SVD, on the second channel estimation information, to obtain the second CSI.

In an embodiment, that the first reference signal is used by the second device to perform channel estimation to determine the first CSI includes: The first reference signal is used by the second device to perform channel estimation to obtain first channel estimation information; and the first CSI is the first channel estimation information; or the first CSI is an eigenvalue or an eigenvector of a channel matrix corresponding to the first channel estimation information.

In an embodiment, that the first device performs channel estimation based on the second reference signal from the second device, to determine the second CSI includes: The first device performs channel estimation based on the second reference signal, to obtain second channel estimation information; and the first device transforms the second channel estimation information by using a channel transformation machine learning model, to obtain fourth channel estimation information, where the second CSI is the fourth channel estimation information; or the second CSI is an eigenvalue or an eigenvector of a channel matrix corresponding to the fourth channel estimation information.

In an embodiment, that the first device performs channel estimation based on the second reference signal from the second device, to determine the second CSI includes: The first device performs channel estimation based on the second reference signal, to obtain second channel estimation information; and the first device transforms the second channel estimation information by using a channel transformation machine learning model, to obtain fourth channel estimation information, where the first device performs eigen-decomposition, for example, SVD, on the fourth channel estimation information, to obtain the second CSI.

In an embodiment, that the first device performs channel estimation based on the second reference signal from the second device, to determine the second CSI includes: The first device performs channel estimation based on the second reference signal, to obtain second channel estimation information; and the first device transforms, by using a channel transformation machine learning model, an eigenvalue or an eigenvector of a channel matrix corresponding to the second channel estimation information, to obtain the second CSI.

In an embodiment, that the first device performs channel estimation based on the second reference signal from the second device, to determine the second CSI includes: The first device performs channel estimation based on the second reference signal, to obtain second channel estimation information; the first device performs eigen-decomposition, for example, SVD, on the second channel estimation information, to obtain an eigenvalue or an eigenvector of a channel matrix corresponding to the second channel estimation information; and the first device transforms, by using a channel transformation machine learning model, an eigenvalue or an eigenvector of a channel matrix corresponding to the second channel estimation information, to obtain the second CSI.

The channel transformation machine learning model is related to channel data distribution. In an implementation, the first device transforms the second channel estimation information by using the channel transformation machine learning model. In an alternative implementation, the first device transforms, by using the channel transformation machine learning model, the eigenvalue or the eigenvector of the channel matrix corresponding to the second channel estimation information. In this way, when channel data distribution in an actual deployment scenario of the first encoder and the first decoder is different from channel data distribution corresponding to the first reference signal and the second reference signal, the second CSI can represent a channel feature in the actual deployment scenario. This helps alleviate, in the actual deployment scenario, performance deterioration of the first encoder or the first decoder that is determined by the second device based on the first channel feature information, that is, reduce, in the actual deployment scenario, a deviation between channel state information recovered by the first decoder and actual channel state information input into the first encoder, to help improve communication quality.

In an embodiment, that the first reference signal is used by the second device to perform channel estimation to determine the first CSI includes: The first reference signal is used by the second device to perform channel estimation to obtain first channel estimation information; third channel estimation information is obtained by transforming the first channel estimation information by using the channel transformation machine learning model; and the first CSI is the third channel estimation information; or the first CSI is an eigenvalue or an eigenvector of a channel matrix corresponding to the third channel estimation information.

In an embodiment, that the first reference signal is used by the second device to perform channel estimation to determine the first CSI includes: The first reference signal is used by the second device to perform channel estimation to obtain first channel estimation information; and the first CSI is obtained by transforming, by using the channel transformation machine learning model, an eigenvalue or an eigenvector of a channel matrix corresponding to the first channel estimation information.

The channel transformation machine learning model is related to channel data distribution. In an implementation, the third channel estimation information is obtained by transforming, by the second device, the first channel estimation information by using the channel transformation machine learning model. In an alternative implementation, the first CSI is obtained by transforming, by using the channel transformation machine learning model, the eigenvalue or the eigenvector of the channel matrix corresponding to the first channel estimation information. In this way, when channel data distribution in an actual deployment scenario of the first encoder and the first decoder is different from channel data distribution corresponding to the first reference signal and the second reference signal, the first CSI can represent a channel feature in the actual deployment scenario. This helps alleviate, in the actual deployment scenario, performance deterioration of the first encoder or the first decoder that is determined by the second device based on the first CSI, that is, reduce, in the actual deployment scenario, a deviation between channel state information recovered by the first decoder and actual channel state information input into the first encoder, to help improve communication quality.

In an embodiment, the method further includes: The first device transforms the first decoder by using a parameter sharing machine learning model, to obtain a second decoder.

In an embodiment, the method further includes: The first device transforms the first encoder by using a parameter sharing machine learning model, to obtain a second encoder.

The parameter sharing machine learning model is related to a communication system parameter configuration. The communication system parameter configuration may include one or more of the following: a quantity of antenna units, a quantity of antenna ports, a quantity of spatial streams, and the like. The first encoder and the first decoder are transformed by using the parameter sharing machine learning model, so that when a communication system parameter configuration in an actual deployment scenario of the first encoder and the first decoder is different from a communication system parameter configuration in a scenario in which the second device determines the first encoder, the second encoder and the second decoder that are obtained through transformation is applicable to the actual deployment scenario, to improve communication quality.

In an embodiment, the first reference signal is a downlink reference signal, and the second reference signal is an uplink reference signal; the first device is a network device or a chip in the network device, and the second device is a terminal device or a chip in the terminal device; and the first CSI and the first channel feature information are used by the second device to determine the first encoder.

In an embodiment, the method further includes: The first device sends one or more of the following to the second device: first information, second information, and third information, where the first information indicates a time-frequency resource position of the first reference signal; the second information indicates a time-frequency resource position of the second reference signal; and the third information indicates a time-frequency resource position of the first channel feature information.

In an embodiment, the first reference signal is an uplink reference signal, and the second reference signal is a downlink reference signal; the first device is a terminal device or a chip in the terminal device, and the second device is a network device or a chip in the network device; and the first CSI and the first channel feature information are used by the second device to determine the first decoder.

In an embodiment, the method further includes: The first device receives one or more of the following from the second device: first information, second information, and third information, where the first information indicates a time-frequency resource position corresponding to the first reference signal; the second information indicates a time-frequency resource position corresponding to the second reference signal; and the third information indicates a time-frequency resource position corresponding to the first channel feature information.

According to a third aspect, this application further provides a communication apparatus. The communication apparatus has a function of implementing some or all of the implementations of the first aspect, or has a function of implementing some or all of the function implementations of the second aspect. The function may be implemented by hardware, or may be implemented by hardware executing corresponding software. The hardware or the software includes one or more units or modules corresponding to the functions.

In a possible design, a structure of the communication apparatus may include a processing unit and a communication unit. The processing unit is configured to support the communication apparatus in performing a corresponding function in the foregoing method. The communication unit is configured to support communication between the communication apparatus and another communication apparatus. The communication apparatus may further include a storage unit. The storage unit is configured to be coupled to the processing unit and the communication unit, and stores program instructions and data that are necessary for the communication apparatus.

In an implementation, the communication apparatus includes a processing unit and a communication unit. The processing unit is configured to control the communication unit to perform data/signaling receiving and sending.

The processing unit is configured to perform channel estimation based on a first reference signal from a first device, to determine first CSI.

The communication unit is configured to send a second reference signal to the first device, where the second reference signal is used by the first device to perform channel estimation to determine second CSI.

The communication unit is further configured to receive first channel feature information from the first device, where the first channel feature information is obtained by compressing, by the first device, the second CSI by using a first encoder.

The processing unit is further configured to determine the first encoder or a first decoder based on the first CSI and the first channel feature information.

A channel corresponding to the first reference signal and a channel corresponding to the second reference signal are reciprocal.

In addition, for another optional implementation of the communication apparatus in this aspect, refer to the related content of the first aspect. Details are not described herein again.

In another implementation, the communication apparatus includes a processing unit and a communication unit. The processing unit is configured to control the communication unit to receive and send data/signaling.

The processing unit is configured to determine a first encoder and a first decoder.

The communication unit is configured to send a first reference signal to a second device, where the first reference signal is used by the second device to perform channel estimation to determine first CSI.

The processing unit is further configured to perform channel estimation based on a second reference signal from the second device, to determine second CSI.

The processing unit is further configured to compress the second CSI by using the first encoder, to obtain first channel feature information.

The communication unit is further configured to send the first channel feature information to the second device.

The first CSI and the first channel feature information are used by the second device to determine the first encoder or the first decoder, and a channel corresponding to the first reference signal and a channel corresponding to the second reference signal are reciprocal.

In addition, for another optional implementation of the communication apparatus in this aspect, refer to the related content of the second aspect. Details are not described herein again.

For example, the communication unit may be a transceiver or a communication interface, the storage unit may be a memory, and the processing unit may be a processor.

In an implementation, the communication apparatus includes a processor and a transceiver. The processor is configured to perform channel estimation based on a first reference signal from a first device, to determine first CSI. The transceiver is configured to send a second reference signal to the first device, where the second reference signal is used by the first device to perform channel estimation to determine second CSI. The transceiver is further configured to receive first channel feature information from the first device, where the first channel feature information is obtained by compressing, by the first device, the second CSI by using a first encoder. The processor is further configured to determine the first encoder or a first decoder based on the first CSI and the first channel feature information. A channel corresponding to the first reference signal and a channel corresponding to the second reference signal are reciprocal.

In addition, for another optional implementation of the communication apparatus in this aspect, refer to the related content of the first aspect. Details are not described herein again.

In another implementation, the communication apparatus includes a processor and a transceiver. The processor is configured to determine a first encoder and a first decoder. The transceiver is configured to send a first reference signal to a second device, where the first reference signal is used by the second device to perform channel estimation to determine first CSI. The processor is further configured to perform channel estimation based on a second reference signal from the second device, to determine second CSI. The processor is further configured to compress the second CSI by using the first encoder, to obtain first channel feature information. The transceiver is further configured to send the first channel feature information to the second device. The first CSI and the first channel feature information are used by the second device to determine the first encoder or the first decoder, and a channel corresponding to the first reference signal and a channel corresponding to the second reference signal are reciprocal.

In addition, for another optional implementation of the communication apparatus in this aspect, refer to the related content of the first aspect. Details are not described herein again.

In another implementation, the communication apparatus is a chip or a chip system. The processing unit may also be represented as a processing circuit or a logic circuit. The transceiver unit may be an input/output interface, an interface circuit, an output circuit, an input circuit, a pin, a related circuit, or the like on the chip or the chip system.

In an implementation process, the processor may be configured to perform, for example, but not limited to, baseband-related processing; and the transceiver or the communication interface may be configured to perform, for example, but not limited to, radio frequency receiving and sending. The foregoing components may be separately disposed on chips that are independent of each other, or at least some or all of the components may be disposed on a same chip. For example, the processor may be further divided into an analog baseband processor and a digital baseband processor. The analog baseband processor and the transceiver (or the communication interface) may be integrated on a same chip, and the digital baseband processor may be disposed on an independent chip. With continuous development of integrated circuit technologies, increasingly more components may be integrated on a same chip. For example, a digital baseband processor and a plurality of application processors (for example, but not limited to, a graphics processor and a multimedia processor) may be integrated on a same chip. The chip may be referred to as a system-on-a-chip (SoC). Whether the components are separately disposed on different chips or integrated and disposed on one or more chips usually depends on a requirement of a product design. This embodiment of this application imposes no limitation on implementations of the foregoing components.

According to a fourth aspect, this application further provides a processor, configured to perform the foregoing methods. In processes of performing these methods, a process of sending the foregoing signal and a process of receiving the foregoing signal in the foregoing methods may be understood as a process of outputting the foregoing signal by the processor and a process of inputting the foregoing signal by the processor. When outputting the foregoing signal, the processor outputs the foregoing signal to a transceiver, so that the transceiver (or a communication interface) transmits the signal. After the foregoing signal is output by the processor, other processing may further need to be performed on the signal, and then a processed signal arrives at the transceiver (or the communication interface). Similarly, when the processor receives the foregoing input signal, the transceiver (or the communication interface) receives the signal, and inputs the signal into the processor. Further, after the transceiver (or the communication interface) receives the signal, other processing may need to be performed on the signal, and then a processed signal is input into the processor.

Operations such as sending and receiving related to the processor may be more generally understood as operations such as input, receiving, and output of the processor, instead of operations such as sending and receiving directly performed by a radio frequency circuit and an antenna, unless otherwise specified, or provided that the operations do not contradict actual functions or internal logic of the operations in related descriptions.

In an implementation process, the processor may be a processor specially configured to perform these methods, or may be a processor that executes computer instructions in a memory to perform these methods, for example, a general-purpose processor. The memory may be a non-transitory memory, for example, a read-only memory (ROM). The memory and the processor may be integrated on a same chip, or may be separately disposed on different chips. A type of the memory and a manner of disposing the memory and the processor are not limited in this embodiment of this application.

According to a fifth aspect, this application further provides a communication system. The system includes at least one first device and at least one second device according to the foregoing aspects. In another possible design, the system may further include another device that interacts with the first device and/or the second device in the solution provided in this application.

According to a sixth aspect, this application provides a computer-readable storage medium. The computer-readable storage medium stores a computer program. When the computer program is run, the method in the first aspect or the second aspect is performed.

According to a seventh aspect, this application further provides a computer program product including instructions. The computer program product includes computer program code. When the computer program code is run, the method in the first aspect or the second aspect is performed.

According to an eighth aspect, this application provides a chip system. The chip system includes a processor and an interface, the interface is configured to obtain a program or instructions, and the processor is configured to invoke the program or the instructions to implement a function in the first aspect, or is configured to invoke the program or the instructions to implement a function in the second aspect. In a possible design, the chip system further includes a memory. The memory is configured to store program instructions and data that are necessary for a terminal. The chip system may include a chip, or may include a chip and another discrete component.

### BRIEF DESCRIPTION OF DRAWINGS

FIG. 1 is a diagram of a communication system according to an embodiment of this application;

FIG. 2 is a diagram of another communication system according to an embodiment of this application;

FIG. 3a is a diagram of a fully connected neural network according to an embodiment of this application;

FIG. 3b is a diagram of optimization of a loss function according to an embodiment of this application;

FIG. 3c is a diagram of gradient backpropagation according to an embodiment of this application;

FIG. 4 is a diagram of an autoencoder according to an embodiment of this application;

FIG. 5 is a diagram of an autoencoder-based MIMO channel compression feedback according to an embodiment of this application;

FIG. 6 is a diagram of an antenna connection according to an embodiment of this application;

FIG. 7 is a diagram of a transmit antenna array according to an embodiment of this application;

FIG. 8 is a diagram of a graph model according to an embodiment of this application;

FIG. 9 is a schematic flowchart of an information transmission method according to an embodiment of this application;

FIG. 10 is a diagram of an encoder and decoder that are based on a graph model according to an embodiment of this application;

FIG. 11 is a diagram of another information transmission method according to an embodiment of this application;

FIG. 12 is a diagram of another information transmission method according to an embodiment of this application;

FIG. 13 is a diagram of another information transmission method according to an embodiment of this application;

FIG. 14 is a diagram of another information transmission method according to an embodiment of this application;

FIG. 15 is a diagram of another information transmission method according to an embodiment of this application;

FIG. 16 is a diagram of another information transmission method according to an embodiment of this application;

FIG. 17 is a diagram of another information transmission method according to an embodiment of this application;

FIG. 18 is a diagram of a structure of a communication apparatus according to an embodiment of this application; and

FIG. 19 is a diagram of a structure of another communication apparatus according to an embodiment of this application.

### DESCRIPTION OF EMBODIMENTS

The following clearly describes the technical solutions in embodiments of this application with reference to the accompanying drawings in embodiments of this application.

To better understand the information transmission method disclosed in embodiments of this application, a communication system applicable to embodiments of this application is described.

Embodiments of this application may be applied to a 4th generation (4G) communication system such as a long term evolution (LTE) system or a 5th generation (5G) communication system such as a new radio (NR) system, or may be applied to a communication system such as a satellite communication system and a short-range communication system, or a communication system that supports integration of a plurality of wireless technologies, or an evolved communication system after 5G, such as a 6th generation (6G) communication system.

In embodiments of this application, a wireless communication system includes but is not limited to: a narrow band-internet of things (NB-IoT) system, a global system for mobile communications (GSM) system, an enhanced data rate for GSM evolution (EDGE) system, a wideband code division multiple access (WCDMA) system, a code division multiple access 2000 (CDMA 2000) system, a time division-synchronous code division multiple access (TD-SCDMA) system, a long term evolution (LTE) system, and three major application scenarios of a next-generation 5G mobile communication system: enhanced mobile broadband (eMBB), ultra-reliable low-latency communication (URLLC), and massive machine-type communication (mMTC), or a mobile communication system after 5G.

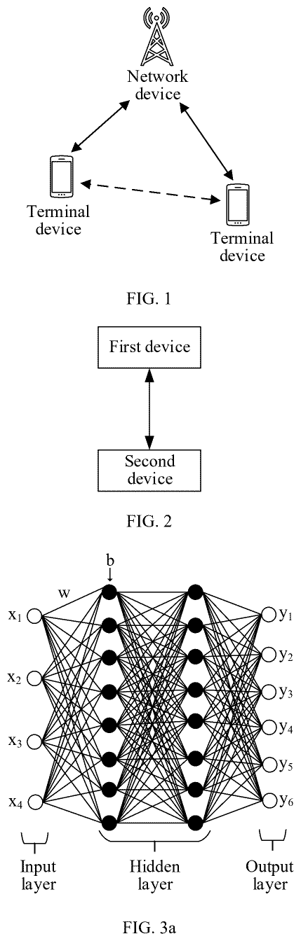

An architecture of a wireless communication system is shown in FIG. 1. The wireless communication system may include one or more network devices and one or more terminal devices. The network device and the terminal device may communicate with each other, and different terminal devices may also communicate with each other. In FIG. 1, an example in which the wireless communication system includes one network device and two terminal devices is used.

FIG. 2 is a diagram of a structure of another communication system according to an embodiment of this application. The communication system includes but is not limited to one first device and one second device. Quantities and forms of devices shown in FIG. 2 are for illustrative purposes and do not constitute a limitation on embodiments of this application. During actual application, there may be two or more first devices and two or more second devices. The first device may be a network device, or may be a terminal device. The second device may be a network device, or may be a terminal device.

In embodiments of this application, the network device is a device having a wireless transceiver function. In a possible scenario, the network device may be a base station, an evolved NodeB (eNodeB), an access point (AP), a transmission reception point (TRP), a next-generation NodeB (gNB), a next generation base station in a 6G mobile communication system, a base station in a future mobile communication system, or the like. The network device may be a macro base station, a micro base station or an indoor base station, a relay node or a donor node, or a wireless controller in a cloud access network (cloud radio access network, C-RAN) scenario. In an embodiment, the network device may alternatively be a server, a wearable device, a vehicle, or a vehicle-mounted device, or may be a device that undertakes a base station function in a mobile switching center and device-to-device (D2D), vehicle-to-everything (V2X), and machine-to-machine (M2M) communication, and the like. For example, an access network device in a vehicle-to-everything (V2X) technology may be a road side unit (RSU).

In another possible scenario, a plurality of network devices assist the terminal device in implementing radio access, and different network devices separately implement some functions of the base station. For example, the network device may be a central unit (CU), a distributed unit (distributed unit, DU), a CU-control plane (CP), a CU-user plane (UP), or a radio unit (RU). The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may also have different names, but a person skilled in the art may understand meanings thereof. For example, in an open wireless access network (ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

In embodiments of this application, the terminal device may also be referred to as user equipment (UE), a terminal, an access terminal, a subscriber unit, a subscriber station, a mobile station (MS), a remote station, a remote terminal, a mobile terminal, a mobile device, a user terminal, a user agent, or a user apparatus, and may be applied to a 4G, 5G, or even 6G system. The terminal may be widely used in various scenarios, for example, device-to-device (D2D) communication, vehicle-to-everything (V2X) communication, machine-type communication (MTC), internet of things (IoT), virtual reality, augmented reality, industrial control, self-driving, telemedicine, a smart grid, smart furniture, smart office, smart wearable, smart transportation, and a smart city. The terminal device in embodiments of this application may be a hand-held device having a wireless communication function, a vehicle-mounted device, a wearable device, a computing device, or another processing device connected to a wireless modem. The terminal device may be a terminal that has a function of connecting to a cellular base station. For example, the terminal device may be a cellular phone (cellular phone), a smartphone (smartphone), a tablet computer (Pad), a wireless data card, a personal digital assistant (PDA) computer, a tablet computer, a wireless modem (modem), a hand-held device (handset), a laptop computer (laptop computer), or a machine-type communication (MTC) terminal. The terminal device may alternatively be a virtual reality (VR) terminal device, an augmented reality (AR) terminal device, a wireless terminal in industrial control (industrial control), a wireless terminal in self-driving (self-driving), a wireless terminal in remote medical (remote medical), a wireless terminal in a smart grid (smart grid), a wireless terminal in transportation safety (transportation safety), a wireless terminal in a smart city (smart city), a wireless terminal in a smart home (smart home), a vehicle-mounted terminal device, a wireless communication device in a smart factory, or the like.

In embodiments disclosed in this application, all aspects, embodiments, or features of this application are presented by describing a system including a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be further used.

To better understand the information transmission method disclosed in embodiments of this application, related concepts in embodiments of this application are briefly described.

### 1. Fully Connected Neural Network

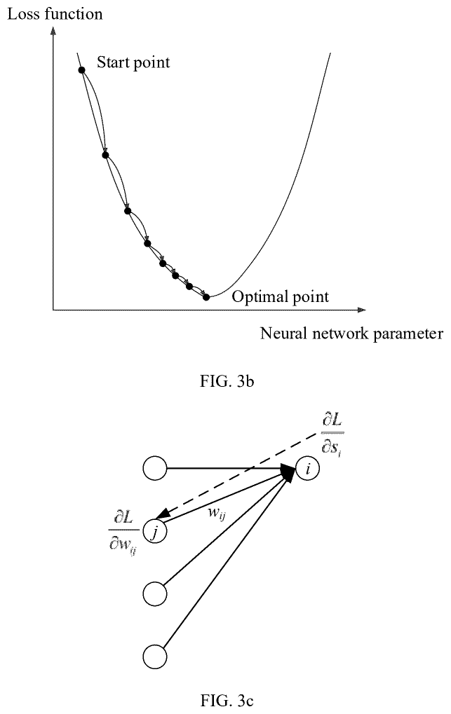

The fully connected neural network may also be referred to as a multilayer perceptron (MLP). One MLP includes one input layer, one output layer, and a plurality of hidden layers, and each layer includes several nodes. The nodes may be referred to as neurons. Neurons at two adjacent layers are connected to each other. For example, an MLP shown in FIG. 3a includes one input layer, one output layer, and two hidden layers. The input layer includes four neurons, each hidden layer includes eight neurons, and the output layer includes six neurons.

For the neurons at the two adjacent layers, an output h of a neuron at a lower layer is obtained by applying an activation function to a weighted sum of all neurons x that are at an upper layer and that are connected to the neuron. The output h may be expressed as shown in Formula (1) by using a matrix.

$$h = f ( wx + b ) \qquad ( 1 )$$

w is a weight matrix, b is a bias vector, and f( ) is an activation function.

In this case, an output of the neural network may be recursively expressed as shown in Formula (2).

$$y = {f}_{n} ( {w}_{n} {f}_{n - 1} ( … ) + {b}_{n} ) \qquad ( 2 )$$

It can be learned that the neural network may represent a mapping relationship from an input data set to an output data set. The neural network is usually randomly initialized, and needs to be put into use after being trained. Training of the neural network is a process of determining the mapping relationship from random w and b by using existing data.

With reference to FIG. 3b, a specific manner for training the neural network includes: evaluating an output result of the neural network by using a loss function (loss function), backpropagating an error, and iteratively optimizing w and b in a gradient descent method until a minimum value of the loss function is obtained. A gradient descent process may be expressed as shown in Formula (3).

$$θ ← θ - η \frac{\partial L}{\partial θ} \qquad ( 3 )$$

θ is a to-be-optimized parameter (for example, w and b), and L is a loss function; and n is learning efficiency, and is used to control a step of gradient descent.

In addition, a chain rule for obtaining a partial derivative is used in a backpropagation process, to be specific, a gradient of a parameter of a former layer may be recursively calculated based on a gradient of a parameter of a latter layer. For example, a gradient of a weight wᵢⱼ between a neuron j and a neuron i in FIG. 3c may be expressed as shown in Formula (4).

$$\frac{\partial L}{\partial {w}_{ij}} = \frac{\partial L}{\partial {s}_{i}} \frac{\partial {s}_{i}}{\partial {w}_{ij}} \qquad ( 4 )$$

sᵢ is an input weighted sum on the neuron i. In addition, in Formula (4),

$$\frac{\partial L}{\partial {s}_{i}}$$

may be referred to as an intermediate layer gradient, that is, sᵢ is considered as an intermediate layer.

### 2. Autoencoder (Autoencoder)

The autoencoder is a machine learning model structure. For example, a neural network model is a type of machine learning model, and the autoencoder may be a neural network model structure. The autoencoder may be configured to represent a group of data, or may be understood as encoding a group of data, and is usually used for data dimension reduction. With reference to FIG. 4, the autoencoder includes an encoder (encoder) and a decoder (decoder). The encoder may be configured to encode input data through one or more layers of neural networks, to obtain a dimension-reduced codeword. The decoder may be configured to reconstruct the codeword into output data through one or more layers of neural networks. It is required that the output data is as similar as possible to the data input into the encoder. The encoder and the decoder need to be jointly trained, so that the output data of the decoder is the same as or basically the same as the input data of the encoder. In addition, the autoencoder may also be referred to as an autoencoder machine learning model, the encoder may also be referred to as an encoder machine learning model, and the decoder may also be referred to as a decoder machine learning model.

### 3. MIMO System Precoding

In a wireless communication system, usually a MIMO technology may be used to increase a system capacity. That is, a plurality of antennas are used at both a transmitting end and a receiving end to transmit signals. In theory, the system capacity can be multiplied through use of the plurality of antennas combined with spatial division multiplexing. However, in practice, use of the plurality of antennas leads to increased interference. Therefore, specific processing needs to be performed on the signals to suppress impact caused by the interference. A method for performing interference suppression through signal processing may be implemented at the receiving end or at the transmitting end. A manner of implementing interference suppression through signal processing at the transmitting end is precoding. Before sending a signal through a MIMO channel, the transmitting end may precode a to-be-sent signal, to suppress interference caused by use of the plurality of antennas.

That the transmitting end precodes the to-be-sent signal may be processing the to-be-sent signal by using a precoding matrix. In principle, singular value decomposition (SVD) may be performed based on an actual channel, to obtain a corresponding precoding matrix. A plurality of channels may be converted into channels in a one-to-one mode similar to a single-input single-output (SISO) mode by performing SVD on the MIMO channel. That is, a plurality of MIMO cross channels are converted into a plurality of parallel one-to-one channels. This helps identify a useful channel in the plurality of MIMO cross channels. Performing SVD on the channel may be shown in Formula (5).

$$H = U \sum {V}^{T} \qquad ( 5 )$$

H is a channel matrix. V is a precoding matrix, and V^{T} is a transposed matrix of V. U and V are orthogonal matrices. Σ is a diagonal matrix whose singular value is a diagonal element.

For example, the transmitting end may process a to-be-sent signal x by using the precoding matrix V, to obtain a processed signal s=Vx. The transmitting end may send the processed signal s, and a signal r received by the receiving end may be shown in Formula (6):

$$r = H \times s + n = U \sum {V}^{T} \times s + n \qquad ( 6 )$$

In this case, the receiving end may decode the received signal r by using Σ⁻¹U^{T}, to obtain a plurality of one-to-one channels without interference. Σ⁻¹ is an inverse matrix of Σ, and U^{T} is a transposed matrix of U.

However, in an actual system, for example, in a frequency-division duplex (FDD) system, the MIMO channel may not be conveniently obtained. In this case, a series of precoding matrices may be predefined, and the series of precoding matrices form a codebook (codebook). A proper precoding matrix may be selected from the codebook through coordination between the transmitting end and the receiving end. In the 3rd generation partnership project (3GPP), a network device may send a downlink reference signal to a terminal device, and the terminal device may perform channel estimation based on a downlink RS, and feed back CSI obtained through channel estimation to the network device. The network device may select, from the codebook based on a precoding matrix indicator (PMI) in the CSI fed back by the terminal device, a precoding matrix that can enable a channel capacity to be maximized, and then process the to-be-sent signal by using the precoding matrix.

### 4. Autoencoder-Based MIMO Channel Compression Feedback

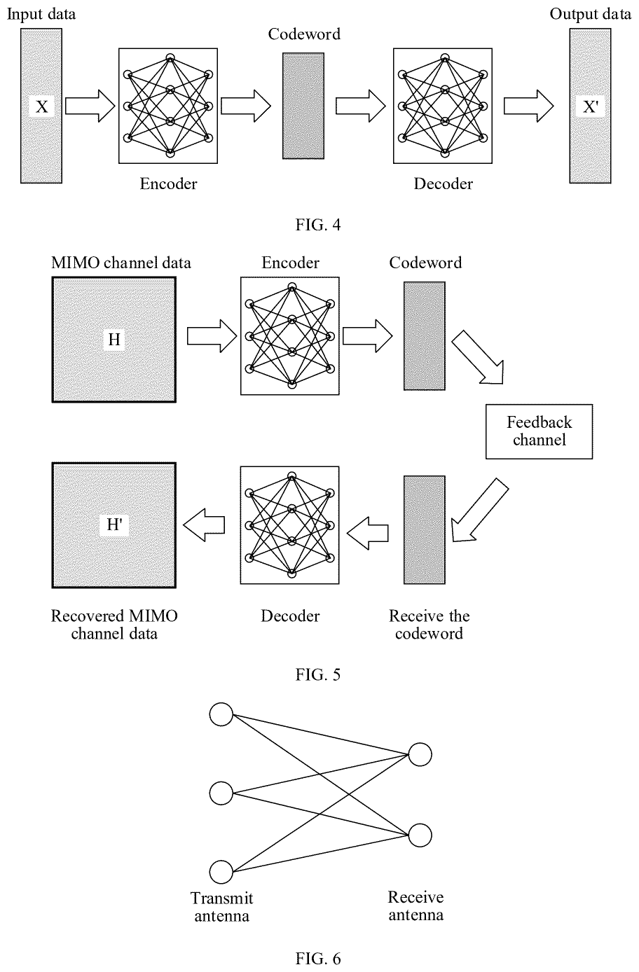

Between a network device and a terminal device, the terminal device may feed back CSI to the network device based on an autoencoder. Specifically, with reference to FIG. 5, an encoder in the autoencoder is deployed in the terminal device, and a decoder is deployed in the network device. The terminal device may estimate a MIMO channel based on a downlink RS from the network device to determine the CSI, input the determined CSI (including MIMO channel data) into the trained encoder, compress the CSI (including the MIMO channel data) based on the encoder, and then send a codeword obtained by compressing by the encoder to the network device through a feedback channel. The network device may input the received codeword into the decoder trained together with the encoder, and reconstruct the MIMO channel based on the decoder, to recover the CSI (including the recovered MIMO channel data) determined by the terminal device. Then, the network device precodes a to-be-sent signal based on the recovered CSI, and then, sends the precoded signal. In this manner, the terminal device compresses the CSI (including the MIMO channel data) by using the encoder, so that dimension reduction can be performed on the CSI. In this way, the codeword transmitted on the feedback channel is CSI obtained through dimension reduction, so that communication overheads can be reduced.

### 5. Graph Neural Network (GNN) Model

The GNN model may also be referred to as a graph model. The following describes graph model construction by using an antenna connection diagram shown in FIG. 6 as an example. In FIG. 6, a quantity Nₜ of transmit antennas at a transmitting end is equal to 3, and a quantity Nᵣ of receive antennas at a receiving end is equal to 2. A channel between each receive antenna and each of the Nₜ transmit antennas may be separately considered to construct the graph model. In this case, an antenna domain-frequency domain channel matrix \tilde{H} is shown in Formula (7).

$$\tilde{H} ∈ {ℂ}^{{\tilde{N}}_{c} \times {N}_{t}} \qquad ( 7 )$$

Ñ_{c} is a quantity of subcarriers.

Two-dimensional discrete Fourier transform (DFT) is performed on H, to obtain an angle domain-time domain channel matrix H̅∈ [symbol] . A truncated channel matrix H∈ [symbol] is obtained by reserving the first N_{c} rows of H̅ in a time domain dimension. Each column of the matrix is used as an attribute of one node in the graph model. If attributes of two nodes are adjacent in the truncated channel matrix, there is an edge between the two nodes. The graph model can be obtained based on the node, the edge, and the node attribute. In this case, for the Nᵣ receive antennas, a total of Nᵣ graph models may be constructed.

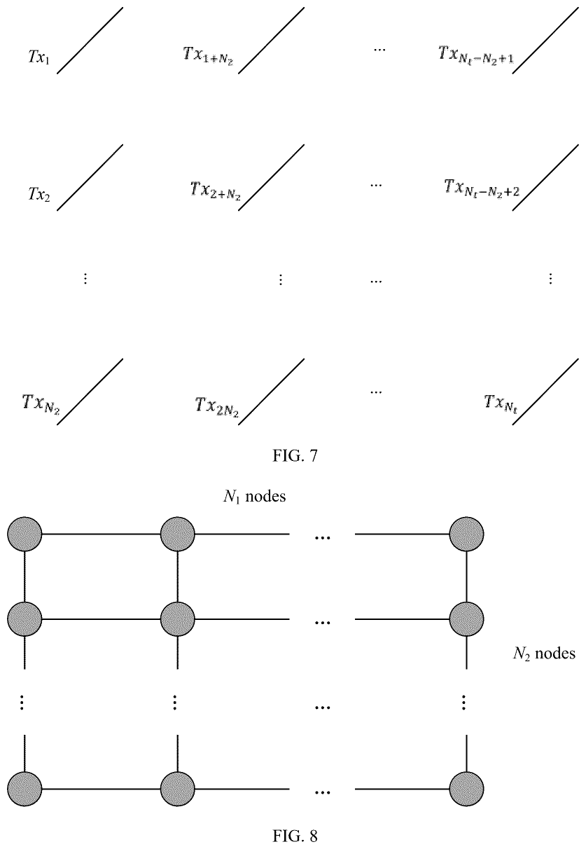

It is assumed that a transmit antenna array is shown in FIG. 7, that is, the Nₜ transmit antennas form an antenna array including N₂ rows and N₁ columns (N₁+N₂=Nₜ). After Fourier transform is performed on the channel matrix, N₁×N₂ angle points in the angle domain may be obtained, and these angle points are nodes in the graph model. Due to sparsity of a time domain, only the first N_{c} values of time domain information need to be reserved. Therefore, a feature of each node is an N_{c}-dimensional complex vector H [:, i]. To facilitate numerical calculation, an imaginary part and a real part of the complex vector H [:, i] are usually separately processed, to form a vector xᵢ whose dimension is 2N_{c} in a cascading manner. Finally, a feature dimension of each node in the graph is 2N_{c}. Considering that adjacent angle points affect each other, in the constructed graph model, there is an edge between the adjacent angle points. For all the N₁×N₂ nodes, an adjacency matrix A∈ [symbol] including N₁×N₂ rows and N₁×N₂ columns is defined. If an element A_{i,j} in an i^{th} row and a j^{th} column of the adjacency matrix A is equal to 1, it indicates that there is an edge between a node i and a node j. If A_{i,j} is equal to 0, it indicates that there is no edge between the node i and the node j. Therefore, a graph model shown in FIG. 8 may be obtained.

The following describes embodiments of this application with reference to the accompanying drawings.

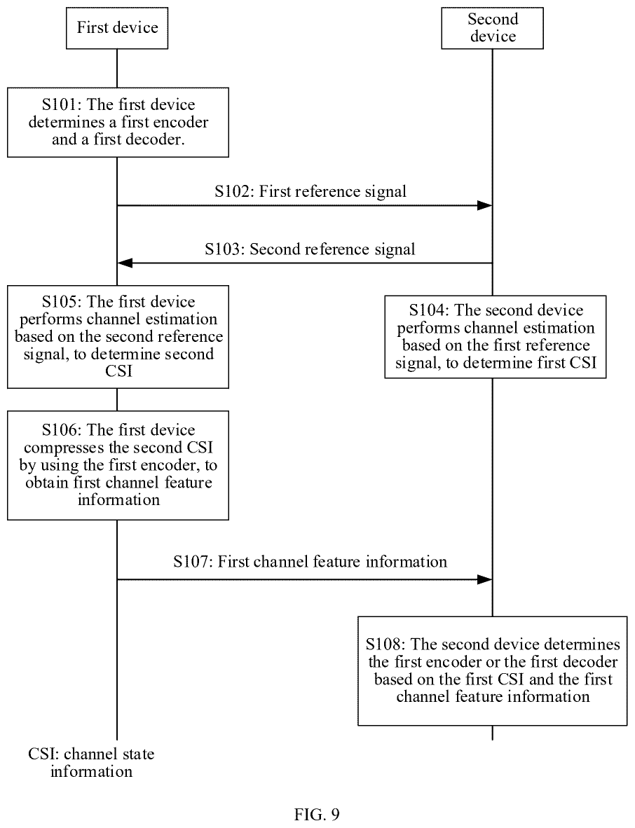

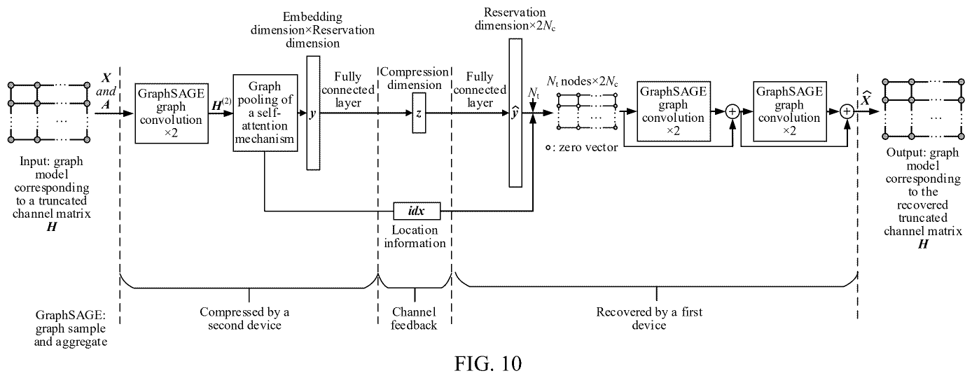

FIG. 9 is a schematic flowchart of an information transmission method according to an embodiment of this application. In the diagram, an example in which a first device and a second device are used as execution entities of the interaction is used to illustrate a corresponding method. However, the execution entities of the interaction are not limited in this application. For example, the first device in the figure may also be a chip, a chip system, or a processor that supports the first device in implementing the corresponding method, or may be a logical module or software that can implement all or some functions of the first device. The second device in the figure may also be a chip, a chip system, or a processor that supports the second device in implementing the corresponding method, or may be a logical module or software that can implement all or some functions of the second device. The information transmission method includes the following operations.

Operation S101: The first device determines a first encoder and a first decoder.

It may be understood that, the first device may train an autoencoder, to obtain the trained autoencoder. That the first device trains the autoencoder includes: The first device performs joint training on an encoder and a decoder. The first encoder determined by the first device in operation S101 is an encoder obtained by performing joint training by the first device, and the first decoder is a decoder obtained by performing joint training by the first device. It may be understood that, the first encoder and the first decoder belong to the same autoencoder, and the first encoder and the first decoder adapt to each other.

Operation S102: The first device sends a first reference signal to the second device; and correspondingly, the second device receives the first reference signal from the first device.

Operation S103: The second device sends a second reference signal to the first device; and correspondingly, the first device receives the second reference signal from the second device.

A channel corresponding to the first reference signal and a channel corresponding to the second reference signal are reciprocal. In this embodiment of this application, a channel corresponding to a reference signal is a channel through which the reference signal passes, or may be understood as a channel carrying the reference signal. Details are not described below again. For example, the channel corresponding to the first reference signal is a channel through which the first reference signal passes, or may be understood as a channel carrying the first reference signal. The channel corresponding to the second reference signal is a channel through which the second reference signal passes, or may be understood as a channel carrying the second reference signal.

For example, the first reference signal and the second reference signal may be transmitted through time division duplexing (TDD), or it may be understood that the first reference signal and the second reference signal are transmitted in a TDD system. In this case, the first reference signal and the second reference signal may be transmitted in different slots with a same frequency resource. An interval between sending time of the first reference signal and sending time of the second reference signal is short, and it may be considered that channel fading experienced by the first reference signal and channel fading experienced by the second reference signal are basically the same. It can be learned that, the channel corresponding to the first reference signal and the channel corresponding to the second reference signal are reciprocal.

Operation S104: The second device performs channel estimation based on the first reference signal, to determine first CSI.

The following describes an embodiment of an operation that the second device performs channel estimation based on the first reference signal, to determine the first CSI, as described in the following optional Implementation 1.1 to Implementation 1.3.

Implementation 1.1: That the second device performs channel estimation based on the first reference signal, to determine the first CSI includes: The second device performs channel estimation based on the first reference signal, to obtain first channel estimation information, where the first CSI is the first channel estimation information; or the first CSI is an eigenvalue or an eigenvector of a channel matrix corresponding to the first channel estimation information.

It may be understood that, the first channel estimation information can represent a feature of the channel corresponding to the first reference signal. In addition, in this embodiment of this application, channel estimation information may be, for example, information that can represent a channel feature, such as time domain information, frequency domain information, time-frequency domain information, or delay-Doppler (delay-Doppler) domain information of a channel. This is not limited. The channel estimation information may be represented by using, for example, a channel matrix or a channel vector. This is not limited.

In an embodiment, the eigenvalue or the eigenvector of the channel matrix corresponding to the first channel estimation information may be an eigenvalue or an eigenvector of a channel matrix obtained by processing the first channel estimation information by the second device. For example, the second device may perform eigen-decomposition on the first channel estimation information, to obtain the eigenvalue or the eigenvector of the channel matrix corresponding to the first channel estimation information. The eigen-decomposition may be, for example, SVD.

In addition, optionally, in addition to such a manner in which the first CSI is the eigenvalue or the eigenvector of the channel matrix corresponding to the first channel estimation information, the first CSI may alternatively be other feature information of the channel matrix corresponding to the first channel estimation information. This is not limited.

Implementation 1.2: That the second device performs channel estimation based on the first reference signal, to determine the first CSI includes: The second device performs channel estimation based on the first reference signal, to obtain first channel estimation information; the second device transforms the first channel estimation information by using a channel transformation machine learning model, to obtain third channel estimation information, where the first CSI is the third channel estimation information; or the first CSI is an eigenvalue or an eigenvector of a channel matrix corresponding to the third channel estimation information. For specific descriptions of the first channel estimation information, refer to related descriptions in Implementation 1.1. Details are not described again.

In an embodiment, the eigenvalue or the eigenvector of the channel matrix corresponding to the third channel estimation information may be an eigenvalue or an eigenvector of a channel matrix obtained by processing the third channel estimation information by the second device. For example, the second device may perform eigen-decomposition on the third channel estimation information, to obtain the eigenvalue or the eigenvector of the channel matrix corresponding to the third channel estimation information. The eigen-decomposition may be, for example, SVD.

In addition, optionally, in addition to such a manner in which the first CSI is the eigenvalue or the eigenvector of the channel matrix corresponding to the third channel estimation information, the first CSI may alternatively be other feature information of the channel matrix corresponding to the third channel estimation information. This is not limited.

Implementation 1.3: That the second device performs channel estimation based on the first reference signal from the first device, to determine the first CSI includes: The second device performs channel estimation based on the first reference signal, to obtain first channel estimation information; and the second device transforms, by using a channel transformation machine learning model, an eigenvalue or an eigenvector of a channel matrix corresponding to the first channel estimation information, to obtain the first CSI. For specific descriptions of the first channel estimation information and the eigenvalue or the eigenvector of the channel matrix corresponding to the first channel estimation information, refer to related descriptions in Implementation 1.1. Details are not described again. In addition, optionally, in addition to such a manner of transforming the eigenvalue or the eigenvector of the channel matrix corresponding to the first channel estimation information to obtain the first CSI, other feature information of the channel matrix corresponding to the first channel estimation information may be transformed to obtain the first CSI. This is not limited.

In addition, in Implementation 1.2 and Implementation 1.3, the channel transformation machine learning model is related to channel data distribution. In Implementation 1.2, an operation that the second device transforms the first channel estimation information by using the channel transformation machine learning model is performed, or in Implementation 1.3, an operation that the second device transforms, by using the channel transformation machine learning model, the eigenvalue or the eigenvector of the channel matrix corresponding to the first channel estimation information is performed. In this way, when channel data distribution in an actual deployment scenario of the first encoder and the first decoder is different from channel data distribution corresponding to the first reference signal and the second reference signal, the first CSI can represent a channel feature in the actual deployment scenario. This helps alleviate, in the actual deployment scenario, performance deterioration of the first encoder or the first decoder that is determined by the second device based on the first CSI, that is, reduce, in the actual deployment scenario, a deviation between channel state information recovered by the first decoder and actual channel state information input into the first encoder, to help improve communication quality. In this embodiment of this application, the actual deployment scenario of the first encoder and the first decoder may be understood as a scenario in which the first encoder and the first decoder are actually used to implement compression feedback of channel state information.

For example, the first reference signal and the second reference signal are transmitted in the TDD system, and the first encoder and the first decoder need to be used between the first device and the second device in an FDD system to implement the compression feedback of the channel state information. Channel data distribution in the FDD system may be different from channel data distribution in the TDD system. If the second device directly uses the first channel estimation information obtained in the TDD system or the eigenvalue or the eigenvector of the channel matrix corresponding to the first channel estimation information as the first CSI, performance of the first encoder or the first decoder that is determined by the second device based on the first CSI may be deteriorated when the first encoder or the first decoder is used in the FDD system, which may be specifically represented as: A deviation between the channel state information recovered by the first decoder and actual channel state information input into the first encoder is large, which affects communication quality. However, in Implementation 1.2, the second device transforms the first channel estimation information by using the channel transformation machine learning model, to determine the first CSI, or in Implementation 1.3, the second device transforms, by using the channel transformation machine learning model, the eigenvalue or the eigenvector of the channel matrix corresponding to the first channel estimation information, to determine the first CSI. In this way, the first encoder or the first decoder that is determined by the second device based on the first CSI is applicable to the channel data distribution in the FDD system, so that performance deterioration caused when the first encoder or the first decoder is used in the FDD system is alleviated, the deviation between the channel state information recovered by the first decoder and the actual channel state information input into the first encoder is reduced, and the communication quality is improved.

In addition, optionally, in Implementation 1.2 and Implementation 1.3, the channel transformation machine learning model used by the second device may be pre-stored in the second device, or may be downloaded by the second device from a storage location of the channel transformation machine learning model during actual deployment and use. This is not limited.

Operation S105: The first device performs channel estimation based on the second reference signal, to determine second CSI.

The following describes an embodiment of an operation that the first device performs channel estimation based on the first reference signal, to determine the second CSI, as described in the following optional Implementation 2.1 to Implementation 2.3.

Implementation 2.1: That the first device performs channel estimation based on the second reference signal from the second device, to determine the second CSI includes: The first device performs channel estimation based on the second reference signal, to obtain second channel estimation information, where the second CSI is the second channel estimation information; or the second CSI is an eigenvalue or an eigenvector of a channel matrix corresponding to the second channel estimation information.

It may be understood that, the second channel estimation information can represent a feature of a channel corresponding to the second reference signal. In addition, Implementation 2.1 may be applied to a scenario in which the second device determines the first CSI in Implementation 1.1.

In an embodiment, the eigenvalue or the eigenvector of the channel matrix corresponding to the second channel estimation information may be: the eigenvalue or the eigenvector of the channel matrix obtained by processing the second channel estimation information by the first device. For example, the first device may perform eigen-decomposition on the second channel estimation information, to obtain the eigenvalue or the eigenvector of the channel matrix corresponding to the second channel estimation information. The eigen-decomposition may be, for example, SVD.

In addition, optionally, in addition to such a manner in which the second CSI is the eigenvalue or the eigenvector of the channel matrix corresponding to the second channel estimation information, the second CSI may alternatively be other feature information of the channel matrix corresponding to the second channel estimation information. This is not limited.

Implementation 2.2: That the first device performs channel estimation based on the second reference signal from the second device, to determine the second CSI includes: The first device performs channel estimation based on the second reference signal, to obtain second channel estimation information; and the first device transforms the second channel estimation information by using a channel transformation machine learning model, to obtain fourth channel estimation information, where the second CSI is the fourth channel estimation information; or the second CSI is an eigenvalue or an eigenvector of a channel matrix corresponding to the fourth channel estimation information. For specific descriptions of the second channel estimation information, refer to related descriptions in Implementation 2.1. Details are not described again. In addition, Implementation 2.2 may be applied to a scenario in which the second device determines the first CSI in Implementation 1.2.

In an embodiment, the eigenvalue or the eigenvector of the channel matrix corresponding to the fourth channel estimation information may be: the eigenvalue or the eigenvector of the channel matrix obtained by processing the fourth channel estimation information by the first device. For example, the first device may perform eigen-decomposition on the fourth channel estimation information, to obtain the eigenvalue or the eigenvector of the channel matrix corresponding to the fourth channel estimation information. The eigen-decomposition may be, for example, SVD.

In addition, optionally, in addition to such a manner in which the second CSI is the eigenvalue or the eigenvector of the channel matrix corresponding to the fourth channel estimation information, the second CSI may alternatively be other feature information of the channel matrix corresponding to the fourth channel estimation information. This is not limited.

Implementation 2.3: That the first device performs channel estimation based on the second reference signal from the second device, to determine the second CSI includes: The first device performs channel estimation based on the second reference signal, to obtain second channel estimation information; and the first device transforms, by using a channel transformation machine learning model, an eigenvalue or an eigenvector of a channel matrix corresponding to the second channel estimation information, to obtain the second CSI. For specific descriptions of the second channel estimation information and the eigenvalue or the eigenvector of the channel matrix corresponding to the second channel estimation information, refer to related descriptions in Implementation 2.1. Details are not described again. In addition, Implementation 2.3 may be applied to a scenario in which the second device determines the first CSI in Implementation 1.3. In addition, optionally, in addition to such a manner of transforming the eigenvalue or the eigenvector of the channel matrix corresponding to the second channel estimation information to obtain the second CSI, other feature information of the channel matrix corresponding to the second channel estimation information may be transformed to obtain the first CSI. This is not limited.

In addition, in Implementation 2.2 and Implementation 2.3, the channel transformation machine learning model is related to channel data distribution. In Implementation 2.2, an operation that the first device transforms the second channel estimation information by using the channel transformation machine learning model is performed, or in Implementation 2.3, an operation that the first device transforms, by using the channel transformation machine learning model, the eigenvalue or the eigenvector of the channel matrix corresponding to the second channel estimation information is performed. In this way, when channel data distribution in an actual deployment scenario of the first encoder and the first decoder is different from channel data distribution corresponding to the first reference signal and the second reference signal, the second CSI can represent a channel feature in the actual deployment scenario. This helps alleviate, in the actual deployment scenario, performance deterioration of the first encoder or the first decoder that is determined by the second device based on first channel feature information (the first channel feature information is obtained by compressing the second CSI by the first device by using the first encoder), that is, reduce, in the actual deployment scenario, a deviation between channel state information recovered by the first decoder and actual channel state information input into the first encoder, to help improve communication quality. For specific descriptions of the channel transformation machine learning model, refer to the foregoing related descriptions. Details are not described again.

In addition, for a scenario in which the second device determines the first CSI in Implementation 1.2 and the first device determines the second CSI in Implementation 2.2, or for a scenario in which the second device determines the first CSI in Implementation 1.3 and the first device determines the second CSI in Implementation 2.3, the channel transformation machine learning model used by the first device is the same as the channel transformation machine learning model used by the second device.

In an embodiment, in Implementation 2.2 and Implementation 2.3, the channel transformation machine learning model used by the first device may be pre-stored in the first device, or may be downloaded by the first device from a storage location of the channel transformation machine learning model during actual deployment and use. This is not limited.

Operation S106: The first device compresses the second CSI by using the first encoder, to obtain the first channel feature information.

It may be understood that, because the first device determines the first encoder in operation S101, in operation S106, the first device may compress the second CSI by using the first encoder determined in operation S101, to obtain the first channel feature information.

Operation S107: The first device sends the first channel feature information to the second device; and correspondingly, the second device receives the first channel feature information from the first device.

Operation S108: The second device determines a first encoder or a first decoder based on the first CSI and the first channel feature information.

It may be understood that, because the channel corresponding to the first reference signal and the channel corresponding to the second reference signal are reciprocal, a channel feature corresponding to the first reference signal is basically the same as a channel feature corresponding to the second reference channel. It can be learnt that, the first CSI determined by performing channel estimation by the second device based on the first reference signal is basically the same as the second CSI determined by performing channel estimation by the first device based on the second reference signal. In this case, channel feature information obtained by compressing the first CSI by the second device by using the first encoder is basically the same as the first channel feature information obtained by compressing the second CSI by the first device by using the first encoder. Therefore, the second device may determine the first encoder based on the first CSI and the first channel feature information. In addition, because the first CSI determined by performing channel estimation by the second device based on the first reference signal is basically the same as the second CSI determined by performing channel estimation by the first device based on the second reference signal, CSI obtained by decompressing the first channel feature information by the second device by using the first decoder is basically the same as the first CSI. Therefore, the second device may determine the first decoder based on the first channel feature information and the first CSI.

In an embodiment, that the second device determines the first encoder based on the first CSI and the first channel feature information may include: operation a: The second device constructs a training dataset based on the first CSI and the first channel feature information, and trains an encoder based on the training dataset. The first device and the second device may repeatedly perform operation S102 to operation S107 and operation a for a plurality of times, so that the second device determines the first encoder, and the first encoder determined by the second device meets a first convergence condition. The following describes optional manners of the first convergence condition, as described in the following optional Implementation 3.1 to Implementation 3.3.

Implementation 3.1: The first convergence condition may be: A quantity of times of repeatedly performing operation S102 to operation S107 and operation a reaches a first value. The first value may be predefined, or may be determined through negotiation between the first device and the second device. This is not limited.

It may be understood that, the first device and the second device may repeatedly perform operation S102 to operation S107 and operation a for the plurality of times, until the quantity of times of repeatedly performing operation S102 to operation S107 and operation a reaches the first value, the first device and the second device may stop repeatedly performing operation S102 to operation S107 and operation a, and the second device may determine, as the first encoder, the trained encoder obtained by performing operation a last time.

Implementation 3.2: The first convergence condition may be: A difference between second channel feature information and third channel feature information is less than a second value. The second channel feature information is obtained by compressing, third CSI by the second device by using the first encoder determined in operation S108, and the third channel feature information is obtained by compressing fourth CSI by the first device by using the first encoder determined in operation S101. The third CSI is determined by performing channel estimation by the second device based on a third reference signal from the first device, and the fourth CSI is determined by performing channel estimation by the first device based on a fourth reference signal from the second device. A channel corresponding to the third reference signal and a channel corresponding to the fourth reference signal are reciprocal. The second value may be predefined, or may be determined through negotiation between the first device and the second device. This is not limited.

For example, after the first device and the second device repeatedly perform operation S102 to operation S107 and operation a for a period of time, the second device may send a reference signal #1 to the first device, and the first device may send a reference signal #2 to the second device. A channel corresponding to the reference signal #1 and a channel corresponding to the reference signal #2 are reciprocal. The first device may perform channel estimation based on the reference signal #1, to determine CSI #1, compress the CSI #1 by using the first encoder determined in operation S101 to obtain channel feature information #1, and send the channel feature information #1 to the second device. The second device may perform channel estimation based on the reference signal #2, to determine CSI #2, and compress the CSI #2 by using the trained encoder obtained by performing operation a last time, to obtain channel feature information #2.

If a difference between the channel feature information #2 and the channel feature information #1 is less than the second value, the second device may determine, as the first encoder, the trained encoder obtained by performing operation a last time, and the first device and the second device stop repeatedly performing operation S102 to operation S107 and operation a. In this case, the reference signal #1 is the fourth reference signal, the reference signal #2 is the third reference signal, the CSI #1 is the fourth CSI, the CSI #2 is the third CSI, the channel feature information #1 is the third channel feature information, and the channel feature information #2 is the second channel feature information.

If a difference between the channel feature information #2 and the channel feature information #1 is greater than or equal to the second value, the first device and the second device may continue to repeatedly perform operation S102 to operation S107 and operation a, until the difference between the second channel feature information and the third channel feature information is less than the second value, and the second device stops repeatedly performing operation S102 to operation S107 and operation a, and determines, as the first encoder, the trained encoder obtained by performing operation a last time.

Implementation 3.3: The first convergence condition may be: A difference between fourth CSI and fifth CSI is less than a third value. The fourth CSI is determined by performing channel estimation by the first device based on a fourth reference signal from the second device, and the fifth CSI is obtained by decompressing second channel feature information from the second device by the first device by using the first decoder determined in operation S101. The second channel feature information is obtained by compressing third CSI by the second device by using the first encoder determined in operation S108, and the third CSI is determined by performing channel estimation by the second device based on a third reference signal from the first device. A channel corresponding to the third reference signal and a channel corresponding to the fourth reference signal are reciprocal. The third value may be predefined, or may be determined through negotiation between the first device and the second device. This is not limited.

If the difference between the fifth CSI and the fourth CSI is less than the third value, it may be considered that a difference between channel state information recovered by decompressing the second channel feature information from the second device by the first device by using the first decoder determined in operation S101 and actual channel state information determined by performing channel estimation by the first device based on the fourth reference signal from the second device is small. It can be learned that, that the first encoder determined by the second device in operation S108 is adapted to the first decoder determined by the first device in operation S101 may also be understood as: The first encoder determined by the second device in operation S108 is the same as the first encoder determined by the first device in operation S101.

For example, after the first device and the second device repeatedly perform operation S102 to operation S107 and operation a for a period of time, the second device may send a reference signal #1 to the first device, and the first device may send a reference signal #2 to the second device. A channel corresponding to the reference signal #1 and a channel corresponding to the reference signal #2 are reciprocal. The second device may perform channel estimation based on the reference signal #2, to determine CSI #2, compress the CSI #2 by using the trained encoder obtained by performing operation a last time, to obtain channel feature information #2, and send the channel feature information #2 to the first device. The first device may perform channel estimation based on the reference signal #1, to determine CSI #1, and decompress the channel feature information #2 by using the first decoder determined in operation S101 to obtain CSI #3.

If a difference between the CSI #3 and the CSI #1 is less than the third value, the first device may send, to the second device, indication information indicating the second device to stop training the encoder. When/after receiving the indication information, the second device may determine, as the first encoder, the trained encoder obtained by performing operation a last time, and the first device and the second device stop repeatedly performing operation S102 to operation S107 and operation a. In this case, the reference signal #1 is the fourth reference signal, the reference signal #2 is the third reference signal, the CSI #1 is the fourth CSI, the CSI #2 is the third CSI, and the CSI #3 is the fifth CSI, and the channel feature information #2 is the second channel feature information.

If a difference between the CSI #3 and the CSI #1 is greater than or equal to the third value, the first device may send, to the second device, indication information indicating the second device to continue to train the encoder, the first device and the second device may continue to repeatedly perform operation S102 to operation S107 and operation a, until the difference between the fifth CSI and the fourth CSI is less than the third value, and the second device stops repeatedly performing operation S102 to operation S107 and operation a, and determines, as the first encoder, the trained encoder obtained by performing operation a last time.

In an embodiment, that the second device determines the first decoder based on the first CSI and the first channel feature information may include: operation b: The second device constructs a training dataset based on the first CSI and the first channel feature information, and trains a decoder based on the training dataset. The first device and the second device may repeatedly perform operation S102 to operation S107 and operation b for a plurality of times, so that the second device determines the first decoder, and the first decoder determined by the second device meets a second convergence condition. The following describes optional manners of the second convergence condition, as described in the following optional Implementation 4.1 and Implementation 4.2.

Implementation 4.1: The second convergence condition may be: A quantity of times of repeatedly performing operation S102 to operation S107 and operation b reaches a first value. The first value may be predefined, or may be determined through negotiation between the first device and the second device. This is not limited.

It may be understood that, the first device and the second device may repeatedly perform operation S102 to operation S107 and operation b for the plurality of times, until the quantity of times of repeatedly performing operation S102 to operation S107 and operation b reaches the first value, the first device and the second device may stop repeatedly performing operation S102 to operation S107 and operation b, and the second device may determine, as the first decoder, the trained decoder obtained by performing operation b last time.

Implementation 4.2: The first convergence condition may be: A difference between third CSI and sixth CSI is less than a fourth value. The third CSI is determined by performing channel estimation by the second device based on a third reference signal from the first device, and the sixth CSI is obtained by decompressing third channel feature information from the first device by the second device by using the first decoder determined in operation S108. The third channel feature information is obtained by compressing fourth CSI by the first device by using the first encoder determined in operation S101, and the fourth CSI is determined by performing channel estimation by the first device based on a fourth reference signal from the second device. A channel corresponding to the third reference signal and a channel corresponding to the fourth reference signal are reciprocal. In addition, the fourth value may be predefined, or may be determined through negotiation between the first device and the second device. This is not limited.

If the difference between the third CSI and the sixth CSI is less than the fourth value, it may be considered that a difference between channel state information recovered by decompressing the third channel feature information from the first device by the second device by using the first decoder determined in operation S108 and actual channel state information determined by performing channel estimation by the second device based on the reference signal from the first device is small. It can be learned that, that the first decoder determined by the second device in operation S108 is adapted to the first encoder determined by the first device in operation S101 may also be understood as: The first decoder determined by the second device in operation S108 is the same as the first decoder determined by the first device in operation S101.

For example, after the first device and the second device repeatedly perform operation S102 to operation S107 and operation b for a period of time, the second device may send a reference signal #1 to the first device, and the first device may send a reference signal #2 to the second device. A channel corresponding to the reference signal #1 and a channel corresponding to the reference signal #2 are reciprocal. The first device may perform channel estimation based on the reference signal #1, to determine CSI #1, compress the CSI #1 by using the first encoder determined in operation S101 to obtain channel feature information #1, and send the channel feature information #1 to the second device. The second device may perform channel estimation based on the reference signal #2, to determine CSI #2, and decompress the channel feature information #1 by using the trained decoder obtained by performing operation a last time to obtain CSI #4.

If a difference between the CSI #4 and the CSI #2 is less than the fourth value, the second device may determine, as the first decoder, the trained decoder obtained by performing operation b last time, and the first device and the second device stop repeatedly performing operation S102 to operation S107 and operation b. In this case, the reference signal #1 is the fourth reference signal, the reference signal #2 is the third reference signal, the CSI #1 is the fourth CSI, the CSI #2 is the third CSI, the CSI #4 is the sixth CSI, and the channel feature information #1 is the third channel feature information.

If a difference between the CSI #4 and the CSI #2 is greater than or equal to the fourth value, the first device and the second device may continue to repeatedly perform operation S102 to operation S107 and operation b, until the difference between the third CSI and the sixth CSI is less than the fourth value, and the second device stops repeatedly performing operation S102 to operation S107 and operation b, and determines, as the first decoder, the trained decoder obtained by performing operation b last time.

In an embodiment, for a scenario in which the second device determines the first encoder in operation S108, the method may further include: The second device transforms the first encoder by using a parameter sharing machine learning model, to obtain a second encoder; and the first device transforms the first decoder by using the parameter sharing machine learning model, to obtain a second decoder.

The parameter sharing machine learning model is related to a communication system parameter configuration. The communication system parameter configuration may include one or more of the following: a quantity of antenna units, a quantity of antenna ports, a quantity of spatial streams, and the like. The first encoder and the first decoder are transformed by using the parameter sharing machine learning model, so that when a communication system parameter configuration in an actual deployment scenario of the first encoder and the first decoder is different from a communication system parameter configuration in a scenario in which the second device determines the first encoder, the second encoder and the second decoder that are obtained through transformation is applicable to the actual deployment scenario, to improve communication quality.

For example, the second device determines the first encoder in the TDD system, and deploys the first encoder and the first decoder in the FDD system. A parameter configuration of the FDD system may be different from a parameter configuration of the TDD system. The second device may transform the first encoder by using the parameter sharing machine learning model, to obtain the second encoder; and the first device may transform the first decoder by using the parameter sharing machine learning model, to obtain the second decoder, so that the second encoder and the second decoder are applicable to the parameter configuration of the FDD system. The first device and the second device implement compression feedback of channel state information by using the second encoder and the second decoder in the FDD system.

In an embodiment, the parameter sharing machine learning model may be a graph model. For specific descriptions of the graph model, refer to the descriptions in the foregoing related concepts. Details are not described again. For example, FIG. 10 shows a case in which the second encoder and the second decoder that are obtained based on the graph model implement the compression feedback of the channel state information. An input of the second encoder is a graph model constructed based on a truncated channel matrix H∈ [symbol] . Specifically, an adjacency matrix A and a node feature matrix X=[x₁; x₂; . . . ; x_{N}_{ₜ}] of the graph model are input into the second encoder. First, a two-layer graph sample and aggregate (GraphSAGE) graph convolution operation is performed on graph data (including the adjacency matrix A and the node feature matrix X). A calculation expression of a convolution operation at a k^{th} layer may be shown in Formula (8).

$${h}_{i}^{( k )} = {W}_{1} {h}_{i}^{( k - 1 )} + {W}_{2} \times m e a {n}_{j ∈ N ( i )} {h}_{j}^{( k - 1 )} \qquad ( 8 )$$

In Formula (8),

$${h}_{i}^{( k )}$$

is an embedding result of a node i at the k^{th} layer, and

$${h}_{i}^{( 0 )} = {x}_{i} ; \{ {W}_{1} , {W}_{2} \}$$

is a to-be-learned parameter; and N(i) represents a set of neighboring nodes of the node i. An objective of the foregoing graph convolution operation is to update information about a node by using information about an angle of a neighboring node, to obtain the embedding result. A dimension of the embedding result is less than a dimension 2N_{c} (for 2N_{c}, refer to the descriptions of the graph model in the foregoing related concepts) of an original feature, so that preliminary channel state information compression is implemented. In addition, the parameter {W₁, W₂} in the foregoing operation is applicable to all nodes. Therefore, the operation in this part is independent of an amount of the input graph data, that is, independent of a quantity of antennas.

After two-layer graph convolution is performed, a pooling operation is performed on the graph data. The pooling operation is essentially a down-sampling process, that is, only some nodes in the graph and a connection relationship between the nodes are reserved, to obtain a subgraph. In this embodiment of this application, a to-be-reserved node and topology structure may be selected by using a self-attention mechanism pooling operation. In this manner, a feature of a node and a topology structure of a graph are fully considered, and a hierarchical representation of the graph can be further learned in an end-to-end manner by using a small quantity of parameters. A key of the self-attention mechanism pooling is to calculate a self-attention score based on the embedding result by using a GNN, reserve the first s nodes with highest scores, and then splice embedding results of the s nodes for subsequent compression. A calculation expression of the self-attention mechanism pooling operation may be shown in the following Formula (9) to Formula (12).

$$score = GNN ( {H}^{( 2 )} , A ) \qquad ( 9 )$$

$$idx = {top}_{s} ( score ) \qquad ( 10 )$$

$${H}^{′} = {H}_{idx}^{( 2 )} \qquad ( 11 )$$

$$y = {‖}_{i = 1}^{s} {H}^{′} \qquad ( 12 )$$

The parameter s in the self-attention mechanism pooling operation is independent of the quantity of antennas. Therefore, a dimension of the vector y in Formula (12) is fixed, and the pooling operation is independent of an amount of the input graph data, that is, independent of the quantity of antennas.

After the pooling operation is performed, the vector y may be input into a fully connected layer and compressed to a given dimension to obtain a vector z. The compressed vector z and a location information vector idx are jointly transmitted to the first device. Corresponding to a part in which the second device performs compression, a part in which the first device performs recovery first includes a fully connected layer. The fully connected layer recovers a dimension of the compressed vector z to a dimension of s×2N_{c}, which corresponds to a feature that the s nodes in the location information vector idx are preliminarily recovered. For a node that is not included in idx, a feature of the node may be padded with a zero vector. The graph data is preliminarily recovered by the fully connected layer and through zero padding. Then, the two-layer GraphSage graph convolution operation is performed on the preliminarily recovered graph data, and a directly connected channel is added in the middle by using a residual network. The graph convolution operation and a direct connection operation are repeated twice, to obtain the finally recovered and reconstructed graph data and a corresponding channel matrix A.

In addition, in this example, one graph model is constructed for each receive antenna in the second device. Therefore, the graph convolution process and the graph pooling process in the CSI compression process performed by the second device are independent of a quantity Nₜ of transmit antennas of the first device. For a graph model corresponding to each receive antenna in the second device, the foregoing operations may be repeated, to implement CSI compression, CSI feedback, and CSI recovery.

In another optional implementation, for a scenario in which the second device determines the first decoder in operation S108, the method may further include: The second device transforms the first decoder by using the parameter sharing machine learning model, to obtain the second decoder; and the first device transforms the first encoder by using the parameter sharing machine learning model, to obtain the second encoder. This implementation is similar to the foregoing implementation in which the parameter sharing machine learning model is used to perform transformation in such a scenario in which the second device determines the first encoder in operation S108. For details, refer to the foregoing related descriptions. Details are not described again.

In an embodiment, the method may further include: The first device and the second device implement the compression feedback of the channel state information based on the first encoder and the first decoder. Alternatively, for such a scenario in which the parameter sharing machine learning model is further used to perform transformation, the method may further include: The first device and the second device implement the compression feedback of the channel state information based on the second encoder and the second decoder.

In another optional implementation, the second device determines that the first encoder or the first decoder may be deployed in another device different from the first device and the second device. For example, after determining the first encoder, the second device may deploy the first encoder in a third device, and deploy the first decoder in a fourth device. The third device and the fourth device may implement the compression feedback of the channel state information based on the first encoder and the first decoder. In an embodiment, the third device may further transform the first encoder by using the parameter sharing machine learning model, to obtain the second decoder; and the fourth device may further transform the first decoder by using the parameter sharing machine learning model, to obtain the second decoder. The third device and the fourth device implement the compression feedback of the channel state information by using the second encoder and the second decoder.

In conclusion, in the information transmission method, the first device determines the first encoder and the first decoder. The first device performs channel estimation based on the second reference signal from the second device, to determine the second CSI, compresses the second CSI by using the first encoder to obtain the first channel feature information, and sends the first channel feature information to the second device. The second device performs channel estimation based on the first reference signal from the first device, to determine the first CSI, and the second device determines the first encoder or the first decoder based on the first CSI and the first channel feature information. The channel corresponding to the first reference signal and the channel corresponding to the second reference signal are reciprocal.

In the information transmission method, reciprocity between the channel corresponding to the first reference signal and the channel corresponding to the second reference signal is used, so that the second device determines the first encoder that adapts to the first decoder in the first device, or the second device determines the first decoder that adapts to the first encoder in the first device. In the information transmission method, the first device does not need to send the second CSI to the second device, so that communication overheads can be reduced. In addition, in the information transmission method, the first device does not need to directly send, to the second device, a model parameter of an encoder obtained through joint training or a model parameter of a decoder obtained through joint training, to ensure that the encoder or the decoder in the first device is private. This helps improve privacy security of the encoder or the decoder in the first device when the first device and the second device are from different vendors.

The following describes, with reference to specific scenarios, an example information transmission method provided in embodiments of this application.

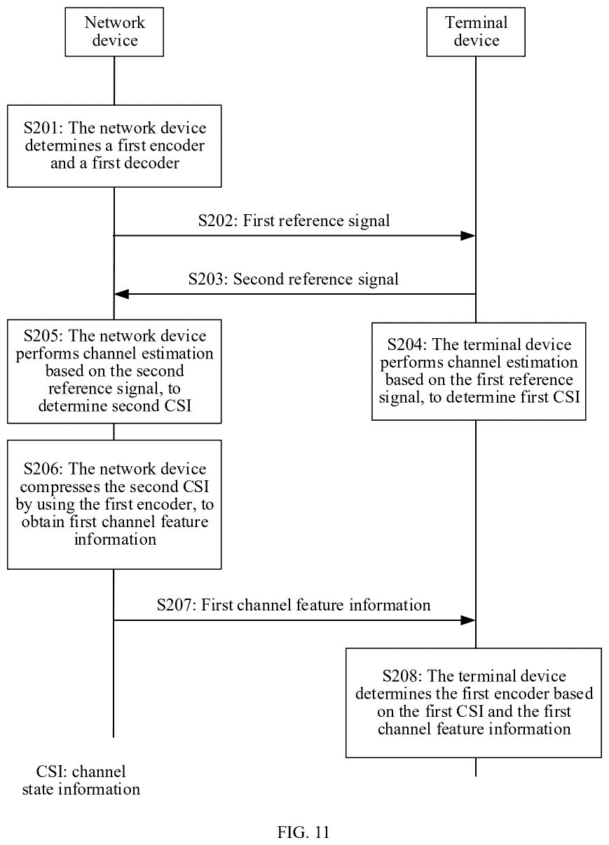

The information transmission method in embodiments of this application may be applied to a scenario of communication between a network device and a terminal device. The terminal device may compress channel state information through an encoder, and feed back the compressed channel state information to the network device. The network device may decompress the compressed channel state information through a decoder, to recover the channel state information. The information transmission method in this scenario may be described in the following Example 1 and Example 2.
Example 1: A first device is the network device or a chip in the network device, and a second device is the terminal device or a chip in the terminal device. In this case, a first reference signal is a downlink reference signal, and a second reference signal is an uplink reference signal; and the second device determines a first encoder based on first CSI and first channel feature information. The following uses an example in which the first device is the network device and the second device is the terminal device. With reference to FIG. 11, the example information transmission method includes the following operation S201 to operation S208.

Operation S201: The network device determines the first encoder and a first decoder.

Operation S202: The network device sends the first reference signal to the terminal device; and correspondingly, the terminal device receives the first reference signal from the network device.

Operation S203: The terminal device sends the second reference signal to the network device; and correspondingly, the network device receives the second reference signal from the terminal device. A channel corresponding to the first reference signal and a channel corresponding to the second reference signal are reciprocal.

In an embodiment, the method further includes: The network device sends one or more of the following to the terminal device: first information, second information, and third information, where the first information indicates a time-frequency resource position of the first reference signal; the second information indicates a time-frequency resource position of the second reference signal; and the third information indicates a time-frequency resource position of the first channel feature information.

For example, a frequency domain resource position of the first reference signal may be configured to be the same as a frequency domain resource position of the second reference signal, and an interval between a time domain resource position of the first reference signal and a time domain resource position of the second reference signal is small, so that the channel corresponding to the first reference signal and the channel corresponding to the second reference signal are reciprocal.

In an embodiment, that the first information indicates the time-frequency resource position of the first reference signal may be: The first information indicates a time-frequency resource position of sending the first reference signal, or the first information indicates a time-frequency resource position of receiving the first reference signal. That the second information indicates the time-frequency resource position of the second reference signal may be: The second information indicates a time-frequency resource position of sending the second reference signal, or the second information indicates a time-frequency resource position of receiving the second reference signal. That the third information indicates the time-frequency resource position of the first channel feature information may be: The third information indicates a time-frequency resource position of sending the first channel feature information, or the third information indicates a time-frequency resource position of receiving the first channel feature information.

In an embodiment, the first information, the second information, and the third information may be carried in same signaling for transmission, or any two or more of the first information, the second information, and the third information may be carried in different signaling for transmission. This is not limited.

Operation S204: The terminal device performs channel estimation based on the first reference signal, to determine the first CSI.

Operation S205: The network device performs channel estimation based on the second reference signal, to determine second CSI.

Operation S206: The network device compresses the second CSI by using the first encoder, to obtain the first channel feature information.

Operation S207: The network device sends the first channel feature information to the terminal device; and correspondingly, the terminal device receives the first channel feature information from the network device.

Operation S208: The terminal device determines the first encoder based on the first CSI and the first channel feature information.

In this embodiment of this application, a sequence of operation S202 and operation S203 is not limited, and a sequence of operation S204 and operation S205 is not limited. For specific descriptions of operation S201 to operation S208, refer to related descriptions in the foregoing information transmission method. Details are not described again.

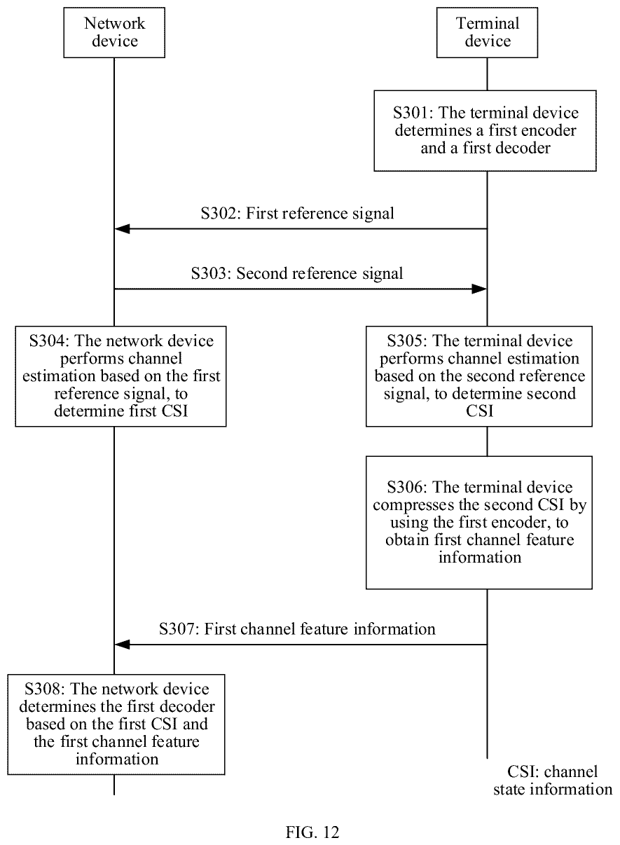

In addition, in an embodiment, when the first device is the network device or the chip in the network device, an RU, a CU, and a DU may cooperatively perform an operation of the first device. For example, the CU or the DU may determine the first encoder and the first decoder, the RU sends the first reference signal to the second device and receives the second reference signal from the second device, the DU performs channel estimation based on the second reference signal, to determine the second CSI, the CU or the DU compresses the second CSI by using the first encoder to obtain the first channel feature information, and the RU sends the first channel feature information to the second device.
Example 2: The first device is the terminal device or a chip in the terminal device, and the second device is the network device or a chip in the network device. In this case, a first reference signal is an uplink reference signal, and a second reference signal is a downlink reference signal; and the second device determines a first decoder based on first CSI and first channel feature information. The following uses an example in which the first device is the terminal device and the second device is the network device. With reference to FIG. 12, the example information transmission method includes the following operation S301 to operation S308.

Operation S301: The terminal device determines a first encoder and the first decoder.

Operation S302: The terminal device sends the first reference signal to the network device; and correspondingly, the network device receives the first reference signal from the terminal device.

Operation S303: The network device sends the second reference signal to the terminal device; and correspondingly, the terminal device receives the second reference signal from the network device. A channel corresponding to the first reference signal and a channel corresponding to the second reference signal are reciprocal.

In an embodiment, the method further includes: The network device sends one or more of the following to the terminal device: first information, second information, and third information, where the first information indicates a time-frequency resource position of the first reference signal; the second information indicates a time-frequency resource position of sending the second reference signal; and the third information indicates a time-frequency resource position of the first channel feature information. For specific descriptions of the first information, the second information, and the third information, refer to related descriptions in the information transmission method shown in FIG. 11. Details are not described again.

Operation S304: The network device performs channel estimation based on the first reference signal, to determine the first CSI.

Operation S305: The terminal device performs channel estimation based on the second reference signal, to determine second CSI.

In an embodiment, the method further includes: The network device sends one or more of the following to the terminal device: first information, second information, and third information, where the first information indicates a time-frequency resource position of the first reference signal; the second information indicates a time-frequency resource position of sending the second reference signal; and the third information indicates a time-frequency resource position of the first channel feature information.

Operation S306: The terminal device compresses the second CSI by using the first encoder, to obtain the first channel feature information.

Operation S307: The terminal device sends the first channel feature information to the network device; and correspondingly, the network device receives the first channel feature information from the terminal device.

Operation S308: The network device determines the first decoder based on the first CSI and the first channel feature information.

In this embodiment of this application, a sequence of operation S302 and operation S303 is not limited, and a sequence of operation S304 and operation S305 is not limited. For specific descriptions of operation S301 to operation S308, refer to related descriptions in the foregoing information transmission method. Details are not described again.

In addition, in an embodiment, when the second device is the network device or the chip in the network device, an RU, a CU, and a DU may cooperatively perform an operation of the second device. For example, the RU may receive the first reference signal from the first device and send the second reference signal to the first device, the DU performs channel estimation based on the first reference signal, to determine the first CSI, the RU receives the first channel feature information from the first device, and the CU or the DU determines the first decoder based on the first CSI and the first channel feature information.

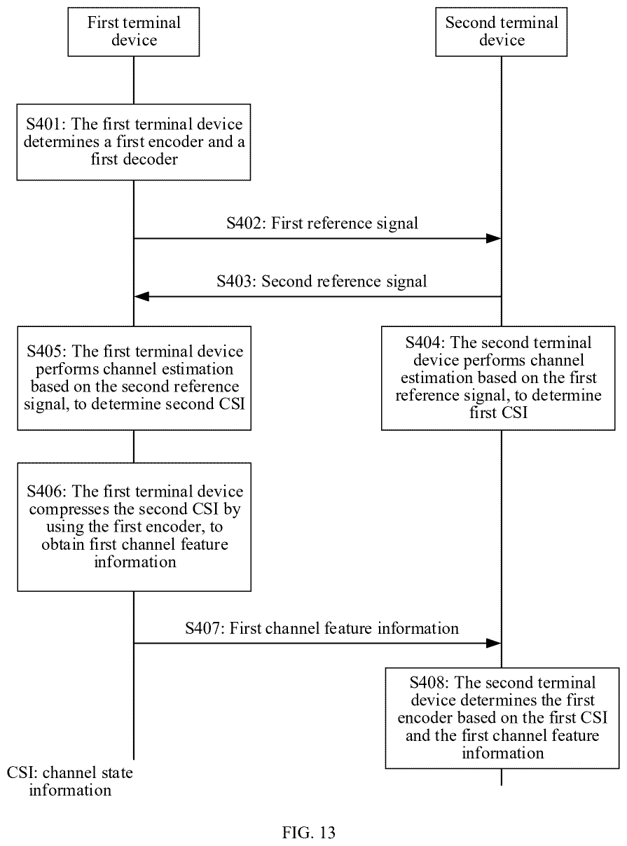

The information transmission method in embodiments of this application may be further applied to a sidelink (sidelink) communication scenario. For example, a second terminal device compresses channel state information through an encoder, and feeds back the compressed channel state information to a first terminal device; and the first terminal device decompresses the compressed channel state information through a decoder, to recover the channel state information. In this scenario, both a first reference signal and a second reference signal are sidelink reference signals. The information transmission method in this scenario may be described in the following Example 3 and Example 4.
Example 3: A first device is the first terminal device or a chip in the first terminal device, and a second device is the second terminal device or a chip in the second terminal device. In this case, the second device determines a first encoder based on first CSI and first channel feature information. The following uses an example in which the first device is the first terminal device and the second device is the second terminal device. With reference to FIG. 13, the example information transmission method includes the following operation S401 to operation S408.

Operation S401: The first terminal device determines the first encoder and a first decoder.

Operation S402: The first terminal device sends the first reference signal to the second terminal device; and correspondingly, the second terminal device receives the first reference signal from the first terminal device.

Operation S403: The second terminal device sends the second reference signal to the first terminal device; and correspondingly, the first terminal device receives the second reference signal from the second terminal device. A channel corresponding to the first reference signal and a channel corresponding to the second reference signal are reciprocal.

In an embodiment, the method further includes: The first terminal device sends one or more of the following to the second terminal device: first information, second information, and third information, where the first information indicates a time-frequency resource position of the first reference signal; the second information indicates a time-frequency resource position of sending the second reference signal; and the third information indicates a time-frequency resource position of the first channel feature information.

In another optional implementation, the method further includes: The network device sends one or more of the following to the first terminal device and the second terminal device: first information, second information, and third information, where the first information indicates a time-frequency resource position of the first reference signal; the second information indicates a time-frequency resource position of sending the second reference signal; and the third information indicates a time-frequency resource position of the first channel feature information.

For specific descriptions of the first information, the second information, and the third information, refer to related descriptions in the information transmission method shown in FIG. 11. Details are not described again.

Operation S404: The second terminal device performs channel estimation based on the first reference signal, to determine the first CSI.

Operation S405: The first terminal device performs channel estimation based on the second reference signal, to determine second CSI.

Operation S406: The first terminal device compresses the second CSI by using the first encoder, to obtain the first channel feature information.

Operation S407: The first terminal device sends the first channel feature information to the second terminal device; and correspondingly, the second terminal device receives the first channel feature information from the first terminal device.

Operation S408: The second terminal device determines the first encoder based on the first CSI and the first channel feature information.

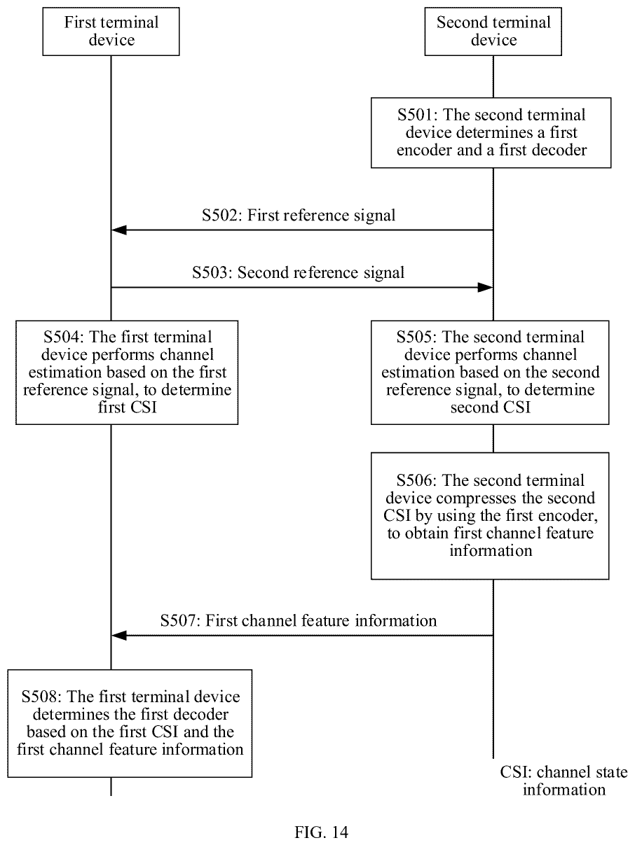

In this embodiment of this application, a sequence of operation S402 and operation S403 is not limited, and a sequence of operation S404 and operation S405 is not limited. In addition, for specific descriptions of operation S401 to operation S408, refer to related descriptions in the foregoing information transmission method. Details are not described again.
Example 4: A first device is the second terminal device or a chip in the second terminal device, and a second device is the first terminal device or a chip in the first terminal device. In this case, the second device determines a first decoder based on first CSI and first channel feature information. The following uses an example in which the first device is the second terminal device and the second device is the first terminal device. With reference to FIG. 14, the example information transmission method includes the following operation S501 to operation S508.

Operation S501: The second terminal device determines a first encoder and the first decoder.

Operation S502: The second terminal device sends the first reference signal to the first terminal device; and correspondingly, the first terminal device receives the first reference signal from the second terminal device.

Operation S503: The first terminal device sends the second reference signal to the second terminal device; and correspondingly, the second terminal device receives the second reference signal from the first terminal device. A channel corresponding to the first reference signal and a channel corresponding to the second reference signal are reciprocal.

In an embodiment, the method further includes: The first terminal device sends one or more of the following to the second terminal device: first information, second information, and third information, where the first information indicates a time-frequency resource position of the first reference signal; the second information indicates a time-frequency resource position of sending the second reference signal; and the third information indicates a time-frequency resource position of the first channel feature information.

In another optional implementation, the method further includes: The network device sends one or more of the following to the first terminal device and the second terminal device: first information, second information, and third information, where the first information indicates a time-frequency resource position of the first reference signal; the second information indicates a time-frequency resource position of sending the second reference signal; and the third information indicates a time-frequency resource position of the first channel feature information.

For specific descriptions of the first information, the second information, and the third information, refer to related descriptions in the information transmission method shown in FIG. 11. Details are not described again.

Operation S504: The first terminal device performs channel estimation based on the first reference signal, to determine the first CSI.

Operation S505: The second terminal device performs channel estimation based on the second reference signal, to determine second CSI.

Operation S506: The second terminal device compresses the second CSI by using the first encoder, to obtain the first channel feature information.

Operation S507: The second terminal device sends the first channel feature information to the first terminal device; and correspondingly, the first terminal device receives the first channel feature information from the second terminal device.

Operation S508: The first terminal device determines the first decoder based on the first CSI and the first channel feature information.

In this embodiment of this application, a sequence of operation S502 and operation S503 is not limited, and a sequence of operation S504 and operation S505 is not limited. In addition, for specific descriptions of operation S501 to operation S508, refer to related descriptions in the foregoing information transmission method. Details are not described again.

The following uses the information transmission method in a case in which the first device is the network device and the second device is the terminal device in Example 1 as an example, to describe an implementation of performing transformation by using a channel transformation machine learning model. Cases in Example 2 to Example 4 are similar to this, and details are not described again.

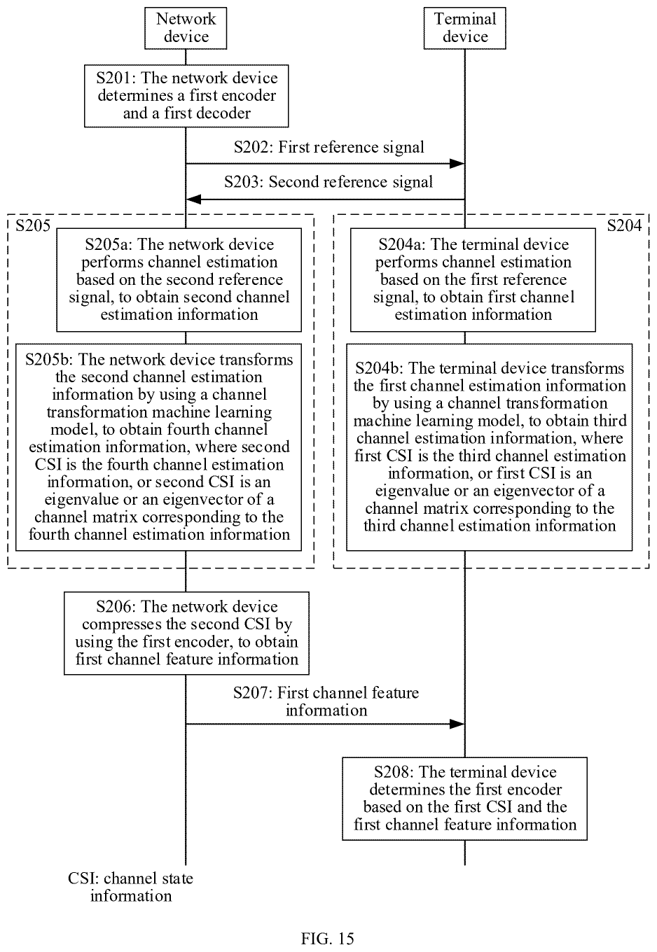

In an embodiment, as shown in FIG. 15, operation S204 in the information transmission method shown in FIG. 11 may include operations S204a and S204b. Operation S205 in the information transmission method shown in FIG. 11 may include operations S205a and S205b.

Operation S204a: The terminal device performs channel estimation based on the first reference signal, to obtain first channel estimation information.

Operation S204b: The terminal device transforms the first channel estimation information by using the channel transformation machine learning model, to obtain third channel estimation information, where the first CSI is the third channel estimation information, or the first CSI is an eigenvalue or an eigenvector of a channel matrix corresponding to the third channel estimation information.

Operation S205a: The network device performs channel estimation based on the second reference signal, to obtain second channel estimation information.

Operation S205b: The network device transforms the second channel estimation information by using the channel transformation machine learning model, to obtain fourth channel estimation information, where the second CSI is the fourth channel estimation information, or the second CSI is an eigenvalue or an eigenvector of a channel matrix corresponding to the fourth channel estimation information.

For specific descriptions of operation S204a, operation S204b, operation S205a, and operation S205b, refer to related descriptions in the foregoing information transmission method. Details are not described again.

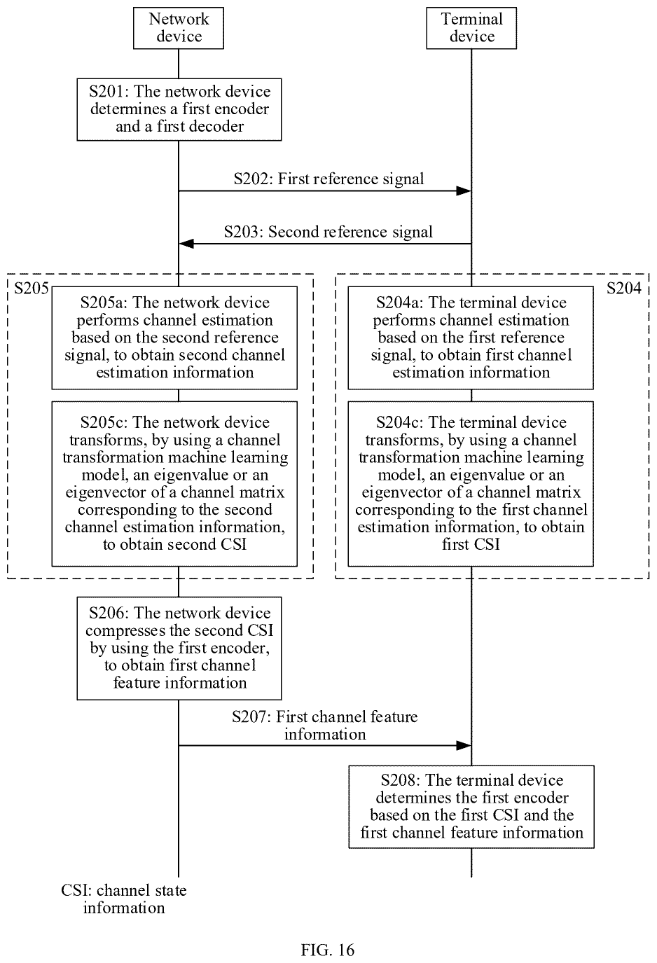

In another optional implementation, as shown in FIG. 16, operation S204 in the information transmission method shown in FIG. 11 may include operations S204a and S204c. Operation S205 in the information transmission method shown in FIG. 11 may include operations S205a and S205c.

Operation S204a: The terminal device performs channel estimation based on the first reference signal, to obtain first channel estimation information.

Operation S204c: The terminal device transforms, by using the channel transformation machine learning model, an eigenvalue or an eigenvector of a channel matrix corresponding to the first channel estimation information, to obtain the first CSI.

Operation S205a: The network device performs channel estimation based on the second reference signal, to obtain second channel estimation information.

Operation S205c: The network device transforms, by using the channel transformation machine learning model, an eigenvalue or an eigenvector of a channel matrix corresponding to the second channel estimation information, to obtain the second CSI.

For specific descriptions of operation S204a, operation S204c, operation S205a, and operation S205c, refer to related descriptions in the foregoing information transmission method. Details are not described again.

The following uses the information transmission method in a case in which the first device is the network device and the second device is the terminal device in Example 1 as an example, to describe an implementation of performing transformation by using a parameter sharing machine learning model. Cases in Example 2 to Example 4 are similar to this, and details are not described again.

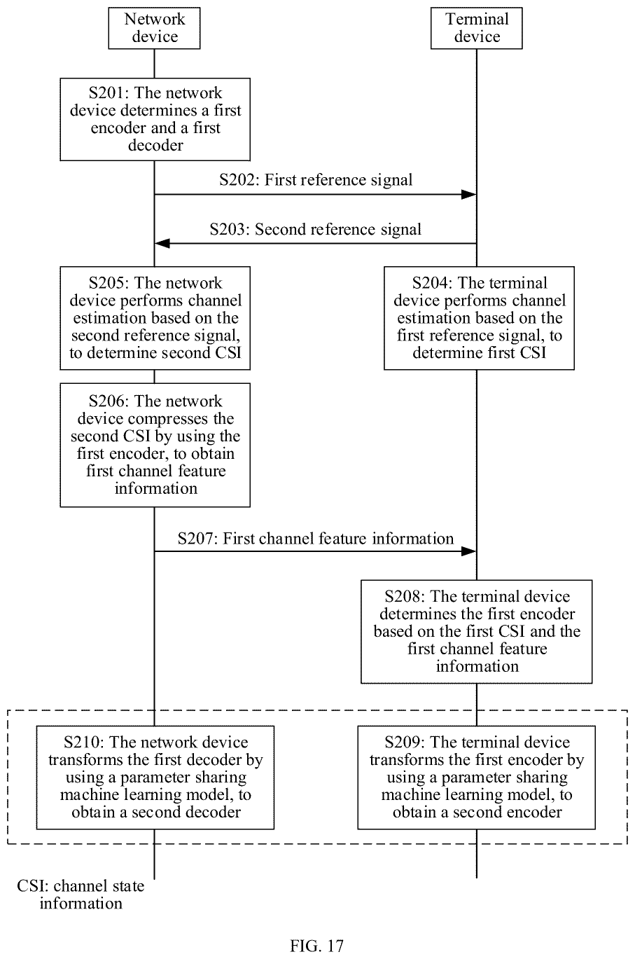

In an embodiment, as shown in FIG. 17, after operation S208 in the information transmission method shown in FIG. 11, operation S209 and operation S210 shown in a dashed-line box in the figure may be further included.

Operation S209: The terminal device transforms the first encoder by using the parameter sharing machine learning model, to obtain a second encoder.

Operation S210: The network device transforms the first decoder by using the parameter sharing machine learning model, to obtain a second decoder.

In this case, the network device and the terminal device may implement compression feedback of channel state information by using the second encoder and the second decoder.

A sequence of operations S209 and S210 is not limited in this embodiment of this application. In addition, for specific descriptions of operation S209 and operation S210, refer to related descriptions in the foregoing information transmission method. Details are not described again.

To implement functions in the foregoing methods provided in embodiments of this application, the first device or the second device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

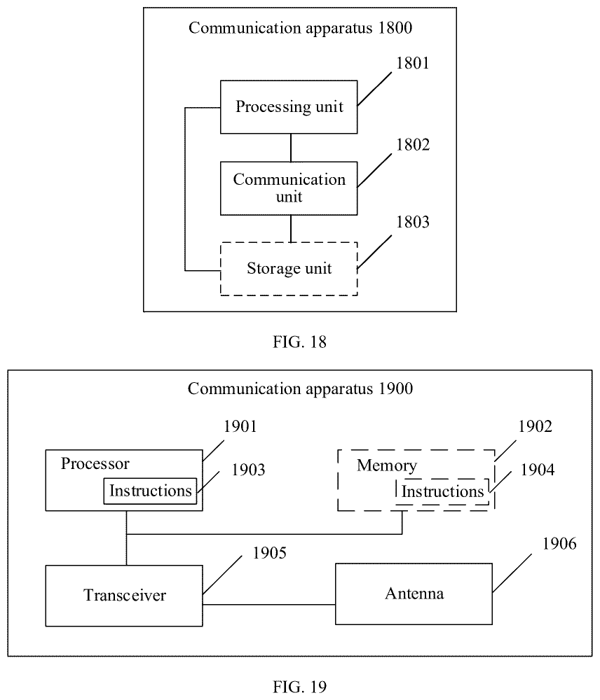

As shown in FIG. 18, an embodiment of this application provides a communication apparatus 1800. The communication apparatus 1800 may be a first device or a second device, may be a component (for example, an integrated circuit or a chip) of the first device, or may be a component (for example, an integrated circuit or a chip) of the second device. Alternatively, the communication apparatus 1800 may be another communication unit, configured to implement the methods in the method embodiments of this application. The communication apparatus 1800 may include a processing unit 1801. In an embodiment, the communication apparatus 1800 may further include a communication unit 1802. The processing unit 1801 is configured to control the communication unit 1802 to receive and send data/signaling. The communication unit 1802 may also be referred to as a transceiver unit. In an embodiment, the communication unit 1802 may include a sending unit and a receiving unit. The sending unit may be configured to send data/signaling, and the receiving unit may be configured to receive data/signaling. In an embodiment, the communication apparatus 1800 may further include a storage unit 1803. The storage unit 1803 may be configured to store information, data, instructions, and/or the like. The storage unit 1803 may interact with the processing unit 1801, or may interact with the communication unit 1802.

In a possible design, for a case in which the communication apparatus 1800 is configured to implement a function of the second device in the foregoing method embodiments, the processing unit 1801 is configured to perform channel estimation based on a first reference signal from a first device, to determine first CSI.

The communication unit 1802 is configured to send a second reference signal to the first device, where the second reference signal is used by the first device to perform channel estimation to determine second CSI.

The communication unit 1802 is further configured to receive first channel feature information from the first device, where the first channel feature information is obtained by compressing, by the first device, the second CSI by using a first encoder.

The processing unit 1801 is further configured to determine the first encoder or a first decoder based on the first CSI and the first channel feature information.

A channel corresponding to the first reference signal and a channel corresponding to the second reference signal are reciprocal.

In an embodiment, for performing channel estimation based on the first reference signal from the first device, to determine the first CSI, the processing unit 1801 is specifically configured to: perform channel estimation based on the first reference signal, to obtain first channel estimation information, where the first CSI is the first channel estimation information; or the first CSI is an eigenvalue or an eigenvector of a channel matrix corresponding to the first channel estimation information.

In an embodiment, for performing channel estimation based on the first reference signal from the first device, to determine the first CSI, the processing unit 1801 is specifically configured to: perform channel estimation based on the first reference signal, to obtain first channel estimation information; and perform eigen-decomposition, for example, SVD, on the first channel estimation information, to obtain the first CSI.

In an embodiment, that the second CSI is determined by performing, by the first device, channel estimation based on the second reference signal includes: Second channel estimation information is obtained by performing, by the first device, channel estimation based on the second reference signal; and the second CSI is the second channel estimation information; or the second CSI is an eigenvalue or an eigenvector of a channel matrix corresponding to the second channel estimation information.

In an embodiment, for performing channel estimation based on the first reference signal from the first device, to determine the first CSI, the processing unit 1801 is specifically configured to: perform channel estimation based on the first reference signal, to obtain first channel estimation information; and transform the first channel estimation information by using a channel transformation machine learning model, to obtain third channel estimation information, where the first CSI is the third channel estimation information; or the first CSI is an eigenvalue or an eigenvector of a channel matrix corresponding to the third channel estimation information.

In an embodiment, for performing channel estimation based on the first reference signal from the first device, to determine the first CSI, the processing unit 1801 is specifically configured to: perform channel estimation based on the first reference signal, to obtain first channel estimation information; transform the first channel estimation information by using a channel transformation machine learning model, to obtain third channel estimation information; and perform eigen-decomposition, for example, SVD, on the third channel estimation information, to obtain the first CSI.

In an embodiment, that the second CSI is determined by performing, by the first device, channel estimation based on the second reference signal includes: Second channel estimation information is obtained by performing, by the first device, channel estimation based on the second reference signal; fourth channel estimation information is obtained by transforming, by the first device, the second channel estimation information by using a channel transformation machine learning model; and the second CSI is the fourth channel estimation information; or the second CSI is an eigenvalue or an eigenvector of a channel matrix corresponding to the fourth channel estimation information.

In an embodiment, for performing channel estimation based on the first reference signal from the first device, to determine the first CSI, the processing unit 1801 is specifically configured to: perform channel estimation based on the first reference signal, to obtain first channel estimation information; and transform, by using a channel transformation machine learning model, an eigenvalue or an eigenvector of a channel matrix corresponding to the first channel estimation information, to obtain the first CSI.

In an embodiment, that the processing unit 1801 performs channel estimation based on the first reference signal from the first device, to determine the first CSI includes: performing channel estimation based on the first reference signal, to obtain first channel estimation information; performing eigen-decomposition, for example, SVD, on the first channel estimation information, to obtain an eigenvalue or an eigenvector of a channel matrix corresponding to the first channel estimation information; and transforming, by using a channel transformation machine learning model, an eigenvalue or an eigenvector of a channel matrix corresponding to the first channel estimation information, to obtain the first CSI.

In an embodiment, that the second CSI is determined by performing, by the first device, channel estimation based on the second reference signal includes: Second channel estimation information is obtained by performing, by the first device, channel estimation based on the second reference signal; and the second CSI is obtained by transforming, by using a channel transformation machine learning model, an eigenvalue or an eigenvector of a channel matrix corresponding to the second channel estimation information.

In an embodiment, the processing unit 1801 is further configured to: after determining the first encoder based on the first CSI and the first channel feature information, transform the first encoder by using a parameter sharing machine learning model, to obtain a second encoder.

In an embodiment, the processing unit 1801 is further configured to: after determining the first decoder based on the first CSI and the first channel feature information, transform the first decoder by using a parameter sharing machine learning model, to obtain a second decoder.

In an embodiment, the first reference signal is a downlink reference signal, and the second reference signal is an uplink reference signal; the communication apparatus 1800 is a terminal device or a chip in the terminal device, and the first device is a network device or a chip in the network device; and the processing unit 1801 determines the first encoder based on the first CSI and the first channel feature information.

In an embodiment, the communication unit 1802 is further configured to receive one or more of the following from the first device: first information, second information, and third information, where the first information indicates a time-frequency resource position of the first reference signal; the second information indicates a time-frequency resource position of the second reference signal; and the third information indicates a time-frequency resource position of the first channel feature information.

In an embodiment, the first reference signal is an uplink reference signal, and the second reference signal is a downlink reference signal; the communication apparatus 1800 is a network device or a chip in the network device, and the first device is a terminal device or a chip in the terminal device; and the processing unit 1801 determines the first decoder based on the first CSI and the first channel feature information.

In an embodiment, the communication unit 1802 is further configured to send one or more of the following to the first device: first information, second information, and third information, where the first information indicates a time-frequency resource position of the first reference signal; the second information indicates a time-frequency resource position of the second reference signal; and the third information indicates a time-frequency resource position of the first channel feature information.

In another possible design, for a case in which the communication apparatus 1800 is configured to implement a function of the first device in the foregoing method embodiments, the processing unit 1801 is configured to determine a first encoder and a first decoder.

The communication unit 1802 is configured to send a first reference signal to a second device, where the first reference signal is used by the second device to perform channel estimation to determine first CSI.

The processing unit 1801 is further configured to perform channel estimation based on a second reference signal from the second device, to determine second CSI.

The processing unit 1801 is further configured to compress the second CSI by using the first encoder, to obtain first channel feature information.

The communication unit 1802 is further configured to send the first channel feature information to the second device.

The first CSI and the first channel feature information are used by the second device to determine the first encoder or the first decoder, and a channel corresponding to the first reference signal and a channel corresponding to the second reference signal are reciprocal.

In an embodiment, for performing channel estimation based on the second reference signal from the second device, to determine the second CSI, the processing unit 1801 is specifically configured to: perform channel estimation based on the second reference signal, to obtain second channel estimation information, where the second CSI is the second channel estimation information; or the second CSI is an eigenvalue or an eigenvector of a channel matrix corresponding to the second channel estimation information.

In an embodiment, for performing channel estimation based on the second reference signal from the second device, to determine the second CSI, the processing unit 1801 is specifically configured to: perform channel estimation based on the second reference signal, to obtain second channel estimation information; and perform eigen-decomposition, for example, SVD, on the second channel estimation information, to obtain the second CSI.

In an embodiment, that the first reference signal is used by the second device to perform channel estimation to determine the first CSI includes: The first reference signal is used by the second device to perform channel estimation to obtain first channel estimation information, where the first CSI is the first channel estimation information; or the first CSI is an eigenvalue or an eigenvector of a channel matrix corresponding to the first channel estimation information.

In an embodiment, for performing channel estimation based on the second reference signal from the second device, to determine the second CSI, the processing unit 1801 is specifically configured to: perform channel estimation based on the second reference signal, to obtain second channel estimation information; and transform the second channel estimation information by using a channel transformation machine learning model, to obtain fourth channel estimation information, where the second CSI is the fourth channel estimation information; or the second CSI is an eigenvalue or an eigenvector of a channel matrix corresponding to the fourth channel estimation information.

In an embodiment, that the processing unit 1801 performs channel estimation based on the second reference signal from the second device, to determine the second CSI includes: performing channel estimation based on the second reference signal, to obtain second channel estimation information; transforming the second channel estimation information by using a channel transformation machine learning model, to obtain fourth channel estimation information; and performing eigen-decomposition, for example, SVD, on the fourth channel estimation information, to obtain the second CSI.

In an embodiment, that the first reference signal is used by the second device to perform channel estimation to determine the first CSI includes: The first reference signal is used by the second device to perform channel estimation to obtain first channel estimation information; third channel estimation information is obtained by transforming the first channel estimation information by using the channel transformation machine learning model; and the first CSI is the third channel estimation information; or the first CSI is an eigenvalue or an eigenvector of a channel matrix corresponding to the third channel estimation information.

In an embodiment, for performing channel estimation based on the second reference signal from the second device, to determine the second CSI, the processing unit 1801 is specifically configured to: perform channel estimation based on the second reference signal, to obtain second channel estimation information; and transform, by using a channel transformation machine learning model, an eigenvalue or an eigenvector of a channel matrix corresponding to the second channel estimation information, to obtain the second CSI.

In an embodiment, that the processing unit 1801 performs channel estimation based on the second reference signal from the second device, to determine the second CSI includes: performing channel estimation based on the second reference signal, to obtain second channel estimation information; performing eigen-decomposition, for example, SVD, on the second channel estimation information, to obtain an eigenvalue or an eigenvector of a channel matrix corresponding to the second channel estimation information; and transforming, by using a channel transformation machine learning model, an eigenvalue or an eigenvector of a channel matrix corresponding to the second channel estimation information, to obtain the second CSI.

In an embodiment, that the first reference signal is used by the second device to perform channel estimation to determine the first CSI includes: The first reference signal is used by the second device to perform channel estimation to obtain first channel estimation information; and the first CSI is obtained by transforming, by using the channel transformation machine learning model, an eigenvalue or an eigenvector of a channel matrix corresponding to the first channel estimation information.

In an embodiment, the processing unit 1801 is further configured to transform the first decoder by using a parameter sharing machine learning model, to obtain a second decoder.

In an embodiment, the processing unit 1801 is further configured to transform the first encoder by using a parameter sharing machine learning model, to obtain a second encoder.

In an embodiment, the first reference signal is a downlink reference signal, and the second reference signal is an uplink reference signal; the communication apparatus 1800 is a network device or a chip in the network device, and the second device is a terminal device or a chip in the terminal device; and the first CSI and the first channel feature information are used by the second device to determine the first encoder.

In an embodiment, the communication unit 1802 is further configured to send one or more of the following to the second device: first information, second information, and third information, where the first information indicates a time-frequency resource position of the first reference signal; the second information indicates a time-frequency resource position of the second reference signal; and the third information indicates a time-frequency resource position of the first channel feature information.

In an embodiment, the first reference signal is an uplink reference signal, and the second reference signal is a downlink reference signal; the communication apparatus 1800 is a terminal device or a chip in the terminal device, and the second device is a network device or a chip in the network device; and the first CSI and the first channel feature information are used by the second device to determine the first decoder.

In an embodiment, the communication unit 1802 is further configured to receive one or more of the following from the second device: first information, second information, and third information, where the first information indicates a time-frequency resource position corresponding to the first reference signal; the second information indicates a time-frequency resource position corresponding to the second reference signal; and the third information indicates a time-frequency resource position corresponding to the first channel feature information.

Embodiments of this application and the foregoing method embodiments are based on a same concept, and have the same the technical effects. For specific principles, refer to the descriptions in the foregoing method embodiments. Details are not described again.

An embodiment of this application further provides a communication apparatus 1900, as shown in FIG. 19. The communication apparatus 1900 may be a first device or a second device, may be a chip, a chip system, or a processor that supports the first device in implementing the foregoing method, or may be a chip, a chip system, or a processor that supports the second device in implementing the foregoing method. The apparatus may be configured to implement the method described in the foregoing method embodiments. For details, refer to the descriptions in the foregoing method embodiments.

The communication apparatus 1900 may include one or more processors 1901. The processor 1901 may be configured to implement some or all functions of the first device or the second device through a logic circuit or running a computer program. The processor 1901 may be a general-purpose processor, a dedicated processor, or the like. For example, the processor may be a baseband processor, a digital signal processor, an application-specific integrated circuit, a field programmable gate array or another programmable logic device, a discrete gate or a transistor logic device, a discrete hardware component, or a central processing unit (CPU). The baseband processor may be configured to process a communication protocol and communication data. The central processing unit may be configured to control the communication apparatus, execute a software program, and process data of the software program. The communication apparatus is, for example, a base station, a baseband chip, a terminal, a terminal chip, a central unit (CU), or a distributed unit (DU).

In an embodiment, the communication apparatus 1900 may include one or more memories 1902. The memory may store instructions 1904. The instructions may be run on the processor 1901, to enable the communication apparatus 1900 to perform the method described in the foregoing method embodiments. In an embodiment, the memory 1902 may further store data. The processor 1901 and the memory 1902 may be separately disposed, or may be integrated together.

The memory 1902 may include but is not limited to a non-volatile memory, for example, a hard disk drive (HDD) or a solid-state drive (SSD), a random access memory (RAM), an erasable programmable read-only memory (EPROM), a ROM or a compact disc read-only memory (CD-ROM), or the like.

In an embodiment, the communication apparatus 1900 may further include a transceiver 1905 and an antenna 1906. The transceiver 1905 may be referred to as a transceiver unit, a transceiver machine, a transceiver circuit, or the like, and is configured to implement a transceiver function. The transceiver 1905 may include a receiver and a transmitter. The receiver may be referred to as a receiver machine, a receiver circuit, or the like, and is configured to implement a receiving function. The transmitter may be referred to as a transmitter machine, a transmitter circuit, or the like, and is configured to implement a sending function.

In a possible design, the processor 1901 is configured to perform channel estimation based on a first reference signal from a first device, to determine first CSI. The transceiver 1905 is configured to send a second reference signal to the first device, where the second reference signal is used by the first device to perform channel estimation to determine second CSI. The transceiver 1905 is further configured to receive first channel feature information from the first device, where the first channel feature information is obtained by compressing, by the first device, the second CSI by using a first encoder. The processor 1901 is further configured to determine the first encoder or a first decoder based on the first CSI and the first channel feature information. A channel corresponding to the first reference signal and a channel corresponding to the second reference signal are reciprocal.

For example, the communication apparatus 1900 may be configured to perform related operations of the second device in the information transmission manner shown in FIG. 9. The processor 1901 may be configured to perform related operations of operation S104 and operation S108 shown in FIG. 9. The transceiver 1905 may be configured to perform a related operation of receiving the first reference signal in operation S102, a related operation of sending the second reference signal in operation S103, and a related operation of receiving the first channel feature information in operation S107 shown in FIG. 9.

In another possible design, the processor 1901 is configured to determine a first encoder and a first decoder. The transceiver 1905 is configured to send a first reference signal to a second device, where the first reference signal is used by the second device to perform channel estimation to determine first CSI. The processor 1901 is further configured to perform channel estimation based on a second reference signal from the second device, to determine second CSI. The processor 1901 is further configured to compress the second CSI by using the first encoder, to obtain first channel feature information. The transceiver 1905 is further configured to send the first channel feature information to the second device. The first CSI and the first channel feature information are used by the second device to determine the first encoder or the first decoder, and a channel corresponding to the first reference signal and a channel corresponding to the second reference signal are reciprocal.

For example, the communication apparatus 1900 may be configured to perform related operations of the first device in the information transmission manner shown in FIG. 9. The processor 1901 may be configured to perform related operations of operation S101, operation S105, and operation S106 shown in FIG. 9. The transceiver 1905 may be configured to perform a related operation of sending the first reference signal in operation S102, a related operation of receiving the second reference signal in S103, and a related operation of sending the first channel feature information in S107 shown in FIG. 9.

In another possible design, the processor 1901 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In another possible design, optionally, the processor 1901 may store instructions 1903. When the instructions 1903 are run on the processor 1901, the communication apparatus 1900 may be enabled to perform the method described in the foregoing method embodiments. The instructions 1903 may be fixed in the processor 1901. In this case, the processor 1901 may be implemented by using hardware.

In another possible design, the communication apparatus 1900 may include a circuit, and the circuit may implement functions of sending, receiving, or communicating in the foregoing method embodiments. The processor and the transceiver described in embodiments of this application may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the transceiver may alternatively be manufactured by using various IC technologies, for example, a complementary metal-oxide-semiconductor (CMOS), an N-channel metal-oxide-semiconductor (NMOS), a P-channel metal-oxide-semiconductor (PMOS), a bipolar junction transistor (BJT), a bipolar CMOS (BiCMOS), silicon germanium (SiGe), and gallium arsenide (GaAs).

A person skilled in the art may further understand that various illustrative logical blocks (illustrative logic blocks) and steps (operations) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the protection scope of embodiments of this application.

Embodiments in this application and the foregoing method embodiments are based on a same concept, and have the same technical effects. For specific principles, refer to the descriptions in the foregoing method embodiments. Details are not described again.

This application further provides a computer-readable storage medium, configured to store computer software instructions. When the instructions are executed by a communication apparatus, a function in any one of the foregoing method embodiments is implemented.

This application further provides a computer program product, configured to store computer software instructions. When the instructions are executed by a communication apparatus, a function in any one of the foregoing method embodiments is implemented.

This application further provides a computer program. When the computer program is run on a computer, a function of any one of the foregoing method embodiments is implemented.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, an SSD), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An information transmission method, wherein the method comprises:
performing channel estimation based on a first reference signal from a first device, to determine first channel state information (CSI);
sending a second reference signal to the first device, wherein the second reference signal is used by the first device to perform channel estimation to determine second CSI;
receiving first channel feature information from the first device, wherein the first channel feature information is obtained by compressing the second CSI by the first device by using a first encoder; and
determining the first encoder or a first decoder based on the first CSI and the first channel feature information, wherein
a channel corresponding to the first reference signal and a channel corresponding to the second reference signal are reciprocal.

2. The method according to claim 1, wherein performing channel estimation based on the first reference signal from the first device, to determine the first CSI comprises one of the following:
performing channel estimation based on the first reference signal, to obtain first channel estimation information, wherein the first CSI is the first channel estimation information; or the first CSI is an eigenvalue or an eigenvector of a channel matrix corresponding to the first channel estimation information; or
performing channel estimation based on the first reference signal, to obtain first channel estimation information, and transforming the first channel estimation information by using a channel transformation machine learning model, to obtain third channel estimation information, wherein the first CSI is the third channel estimation information; or the first CSI is an eigenvalue or an eigenvector of a channel matrix corresponding to the third channel estimation information; or
performing channel estimation based on the first reference signal, to obtain first channel estimation information, and transforming, by using a channel transformation machine learning model, an eigenvalue or an eigenvector of a channel matrix corresponding to the first channel estimation information, to obtain the first CSI.

3. The method according to claim 1, wherein that the second CSI is determined by performing channel estimation by the first device based on the second reference signal comprises one of the following:
second channel estimation information is obtained by performing channel estimation by the first device based on the second reference signal, and the second CSI is the second channel estimation information; or the second CSI is an eigenvalue or an eigenvector of a channel matrix corresponding to the second channel estimation information; or
second channel estimation information is obtained by performing channel estimation by the first device based on the second reference signal, fourth channel estimation information is obtained by transforming the second channel estimation information by the first device by using a channel transformation machine learning model, and the second CSI is the fourth channel estimation information; or the second CSI is an eigenvalue or an eigenvector of a channel matrix corresponding to the fourth channel estimation information; or
second channel estimation information is obtained by performing channel estimation by the first device based on the second reference signal, and the second CSI is obtained by transforming, by using a channel transformation machine learning model, an eigenvalue or an eigenvector of a channel matrix corresponding to the second channel estimation information.

4. The method according to claim 1, wherein the method further comprises:
after determining the first encoder based on the first CSI and the first channel feature information, transforming the first encoder by using a parameter sharing machine learning model, to obtain a second encoder.

5. The method according to claim 1, wherein the method further comprises:
after determining the first decoder based on the first CSI and the first channel feature information, transforming the first decoder by using a parameter sharing machine learning model, to obtain a second decoder.

6. The method according to claim 1, wherein
the first reference signal is a downlink reference signal, and the second reference signal is an uplink reference signal;
an execution entity of the method is a terminal device or a chip in the terminal device, and the first device is a network device or a chip in the network device; and
the first encoder is determined based on the first CSI and the first channel feature information.

7. The method according to claim 6, wherein the method further comprises:
receiving one or more of the following from the first device: first information, second information, and third information, wherein
the first information indicates a time-frequency resource position of the first reference signal;
the second information indicates a time-frequency resource position of the second reference signal; and
the third information indicates a time-frequency resource position of the first channel feature information.

8. The method according to claim 1, wherein
the first reference signal is an uplink reference signal, and the second reference signal is a downlink reference signal;
an execution entity of the method is a network device or a chip in the network device, and the first device is a terminal device or a chip in the terminal device; and
the first decoder is determined based on the first CSI and the first channel feature information.

9. The method according to claim 8, wherein the method further comprises:
sending one or more of the following to the first device: first information, second information, and third information, wherein
the first information indicates a time-frequency resource position of the first reference signal;
the second information indicates a time-frequency resource position of the second reference signal; and
the third information indicates a time-frequency resource position of the first channel feature information.

10. An information transmission method, wherein the method comprises:
determining a first encoder and a first decoder;
sending a first reference signal to a second device, wherein the first reference signal is used by the second device to perform channel estimation to determine first channel state information (CSI);
performing channel estimation based on a second reference signal from the second device, to determine second CSI;
compressing the second CSI by using the first encoder, to obtain first channel feature information; and
sending the first channel feature information to the second device, wherein
the first CSI and the first channel feature information are used by the second device to determine the first encoder or the first decoder, and a channel corresponding to the first reference signal and a channel corresponding to the second reference signal are reciprocal.

11. The method according to claim 10, wherein performing channel estimation based on the second reference signal from the second device, to determine the second CSI comprises one of the following:
performing channel estimation based on the second reference signal, to obtain second channel estimation information, wherein the second CSI is the second channel estimation information; or the second CSI is an eigenvalue or an eigenvector of a channel matrix corresponding to the second channel estimation information; or
performing channel estimation based on the second reference signal, to obtain second channel estimation information, and transforming the second channel estimation information by using a channel transformation machine learning model, to obtain fourth channel estimation information, wherein the second CSI is the fourth channel estimation information; or the second CSI is an eigenvalue or an eigenvector of a channel matrix corresponding to the fourth channel estimation information; or
performing channel estimation based on the second reference signal, to obtain second channel estimation information, and transforming, by using a channel transformation machine learning model, an eigenvalue or an eigenvector of a channel matrix corresponding to the second channel estimation information, to obtain the second CSI.

12. The method according to claim 10, wherein that the first reference signal is used by the second device to perform channel estimation to determine the first CSI comprises one of the following:
the first reference signal is used by the second device to perform channel estimation to obtain first channel estimation information, and the first CSI is the first channel estimation information; or the first CSI is an eigenvalue or an eigenvector of a channel matrix corresponding to the first channel estimation information; or
the first reference signal is used by the second device to perform channel estimation to obtain first channel estimation information, third channel estimation information is obtained by transforming the first channel estimation information by using the channel transformation machine learning model, and the first CSI is the third channel estimation information; or the first CSI is an eigenvalue or an eigenvector of a channel matrix corresponding to the third channel estimation information; or
the first reference signal is used by the second device to perform channel estimation to obtain first channel estimation information, and the first CSI is obtained by transforming, by using the channel transformation machine learning model, an eigenvalue or an eigenvector of a channel matrix corresponding to the first channel estimation information.

13. The method according to claim 10, wherein the method further comprises:
transforming the first decoder by using a parameter sharing machine learning model, to obtain a second decoder.

14. The method according to claim 10, wherein the method further comprises:
transforming the first encoder by using a parameter sharing machine learning model, to obtain a second encoder.

15. The method according to claim 10, wherein
the first reference signal is a downlink reference signal, and the second reference signal is an uplink reference signal;
an execution entity of the method is a network device or a chip in the network device, and the second device is a terminal device or a chip in the terminal device; and
the first CSI and the first channel feature information are used by the second device to determine the first encoder.

16. The method according to claim 15, wherein the method further comprises:
sending one or more of the following to the second device: first information, second information, and third information, wherein
the first information indicates a time-frequency resource position of the first reference signal;
the second information indicates a time-frequency resource position of the second reference signal; and
the third information indicates a time-frequency resource position of the first channel feature information.

17. The method according to claim 10, wherein
the first reference signal is an uplink reference signal, and the second reference signal is a downlink reference signal;
an execution entity of the method is a terminal device or a chip in the terminal device, and the second device is a network device or a chip in the network device; and
the first CSI and the first channel feature information are used by the second device to determine the first decoder.

18. A communication apparatus, comprising a processor, wherein
the processor is configured to execute a computer program or instructions in a memory, to enable the communication apparatus to:
perform channel estimation based on a first reference signal from a first device, to determine first channel state information (CSI);
send a second reference signal to the first device, wherein the second reference signal is used by the first device to perform channel estimation to determine second CSI;
receive first channel feature information from the first device, wherein the first channel feature information is obtained by compressing the second CSI by the first device by using a first encoder; and
determine the first encoder or a first decoder based on the first CSI and the first channel feature information, wherein a channel corresponding to the first reference signal and a channel corresponding to the second reference signal are reciprocal.

19. The apparatus according to claim 18, wherein perform channel estimation based on the first reference signal from the first device, to determine the first CSI comprises one of the following:
perform channel estimation based on the first reference signal, to obtain first channel estimation information, wherein the first CSI is the first channel estimation information; or the first CSI is an eigenvalue or an eigenvector of a channel matrix corresponding to the first channel estimation information; or
perform channel estimation based on the first reference signal, to obtain first channel estimation information, and transform the first channel estimation information by using a channel transformation machine learning model, to obtain third channel estimation information, wherein the first CSI is the third channel estimation information; or the first CSI is an eigenvalue or an eigenvector of a channel matrix corresponding to the third channel estimation information; or
perform channel estimation based on the first reference signal, to obtain first channel estimation information, and transform, by using a channel transformation machine learning model, an eigenvalue or an eigenvector of a channel matrix corresponding to the first channel estimation information, to obtain the first CSI.

20. The apparatus according to claim 18, wherein that the second CSI is determined by performing channel estimation by the first device based on the second reference signal comprises one of the following:
second channel estimation information is obtained by performing channel estimation by the first device based on the second reference signal, and the second CSI is the second channel estimation information; or the second CSI is an eigenvalue or an eigenvector of a channel matrix corresponding to the second channel estimation information; or
second channel estimation information is obtained by performing channel estimation by the first device based on the second reference signal, fourth channel estimation information is obtained by transforming the second channel estimation information by the first device by using a channel transformation machine learning model, and the second CSI is the fourth channel estimation information; or the second CSI is an eigenvalue or an eigenvector of a channel matrix corresponding to the fourth channel estimation information; or
second channel estimation information is obtained by performing channel estimation by the first device based on the second reference signal, and the second CSI is obtained by transforming, by using a channel transformation machine learning model, an eigenvalue or an eigenvector of a channel matrix corresponding to the second channel estimation information.
